(19) United States
(12) Patent Application Publication
(10) Pub. No.: US 2015/0321581 A1
(43) Pub. Date: Nov. 12, 2015

(54) SEAT DRIVING APPARATUS

(71) Applicant: Aisin Seiki Kabushiki Kaisha, Kariya-shi (JP)

(72) Inventor: Sadao ITO, Anjo-shi (JP)

(73) Assignee: Aisin Seiki Kabushiki Kaisha, Kariya-shi (JP)

(21) Appl. No.: 14/699,052

(22) Filed: Apr. 29, 2015

(30) Foreign Application Priority Data
May 7, 2014 (JP) 2014-095977
Oct. 14, 2014 (JP) 2014-209966

(51) Int. Cl. B60N 2/02; H02K 7/10

(52) U.S. Cl. CPC B60N 2/0232; H02K 7/10

(57) ABSTRACT

A seat driving apparatus includes: a rotary motor; operation members arranged so as to correspond to positional adjustment mechanisms; clutch mechanisms arranged so as to correspond to the positional adjustment mechanisms and selectively connecting the corresponding positional adjustment mechanism with the rotary motor; switch cam members sharing a same first rotary axis so as to be pivotally supported thereabout, respectively joined to the operation members so as to be driven therewith, and respectively including switch cam portions; a switch lever pivotally supported about a second rotary axis, including a pressed portion and regulation portions, causing the pressed portion to be pressed by the corresponding switch cam portion, and causing the regulation portion to block turning tracks of other switch cam portions; and a switch electrifying the rotary motor through a polarity coping with a turning direction in response to the turning of the switch lever.

### CROSS REFERENCE TO RELATED APPLICATIONS

This application is based on and claims priority under 35 U.S.C. §119 to Japanese Patent Applications 2014-95977 and 2014-209966, filed on May 7, 2014 and Oct. 14, 2014, respectively, the entire contents of which are incorporated herein by reference.

### TECHNICAL FIELD

This disclosure relates to a seat driving apparatus in which a plurality of positional adjustment mechanisms are selectively activated by a rotary motor.

### BACKGROUND DISCUSSION

JP 2013-107624A (Reference 1, FIGS. 12 to 14, FIGS. 40 and 41) discloses a known seat driving apparatus in the related art, for example. The apparatus includes a plurality of operation handles, a plurality of switch cam members that are respectively joined to the operation handles to be driven therewith, and a switch lever that activates a switch so as to electrify a rotary motor. If any one of the plurality of operation handles is operated, any one of the switch cam members corresponding to the operation handle turns, thereby pressing the switch lever. Accordingly, the switch lever turns and the switch is activated so as to electrify the rotary motor through a polarity coping with a turning direction thereof.

In addition, there is provided a stop cam that is turned by any one of the plurality of switch cam members when the switch cam member turns, thereby regulating turning of other switch cam members. Therefore, if any one of the plurality of operation handles is operated, the corresponding switch cam member turns causing the stop cam to regulate turning of other switch cam members. Then, other operation handles which are respectively joined to other switch cam members to be driven therewith become inoperative (hereinafter, also referred to as “prohibition on follow-up activation”). In other words, the operation of the first operation handle is prioritized so that other operation handles become inoperative.

Incidentally, according to Reference 1, there is a need to provide the stop cam for prohibiting the follow-up activation of the operation handles, and thus, a structure is unavoidably increased in size in order to prohibit the follow-up activation.

### SUMMARY

Thus, a need exists for a seat driving apparatus which is not susceptible to the drawback mentioned above.

A seat driving apparatus according to an aspect of this disclosure includes a rotary motor; a plurality of operation members that are individually arranged so as to correspond to a plurality of positional adjustment mechanisms; a plurality of clutch mechanisms that are individually arranged so as to correspond to the plurality of positional adjustment mechanisms and selectively connect the corresponding positional adjustment mechanism with the rotary motor in accordance with an operation of any one of the plurality of operation members; a plurality of switch cam members that share a same first rotary axis so as to be pivotally supported thereabout, are respectively joined to the plurality of operation members so as to be driven therewith, and respectively include switch cam portions; a switch lever that is pivotally supported about a second rotary axis different from the first rotary axis of the plurality of switch cam members, includes a pressed portion protruding in a radial direction and a pair of regulation portions protruding in the radial direction from both sides interposing the pressed portion in a circumferential direction, causes the pressed portion to be pressed by the corresponding switch cam portion of the switch cam member so as to turn when any one of the plurality of operation members is in operation, and causes the regulation portion to block turning tracks of other switch cam portions of the switch cam members during the turning thereof; and a switch that electrifies the rotary motor through a polarity coping with a turning direction in response to the turning of the switch lever.

### BRIEF DESCRIPTION OF THE DRAWINGS

The foregoing and additional features and characteristics of this disclosure will become more apparent from the following detailed description considered with the reference to the accompanying drawings, wherein:

FIG. 1 is a perspective view of an eight-way power seat to which a first embodiment of this disclosure is applied;

FIG. 2 is an exploded perspective view illustrating the same embodiment;

FIG. 3 is another exploded perspective view illustrating the same embodiment;

FIG. 4 is a cross-sectional view illustrating the same embodiment;

FIG. 5 is an enlarged view of FIG. 4;

FIGS. 6A and 6B are arrow views of the arrow A in FIG. 3, FIG. 6A illustrates a non-operation state of operation handles, and FIG. 6B illustrates an operation state of the operation handles;

FIG. 7 is a perspective view illustrating the same embodiment;

FIG. 8 is a plan view illustrating the same embodiment;

FIGS. 9A and 9B are enlarged views of FIGS. 6A and 6B;

FIGS. 10A and 10B are perspective views illustrating a first cam member and a second cam member;

FIG. 11 is an equivalent circuit schematic illustrating an electrical configuration of the same embodiment;

FIG. 12 is an exploded perspective view illustrating a second embodiment of this disclosure;

FIG. 13 is a perspective view illustrating the same embodiment;

FIG. 14 is an arrow view of the arrow B in FIG. 13 illustrating an operation of the same embodiment; and

FIG. 15 is another arrow view of the arrow B in FIG. 13 illustrating an operation of the same embodiment.

### DETAILED DESCRIPTION

### First Embodiment

Hereinafter, a first embodiment of a seat driving apparatus will be described.

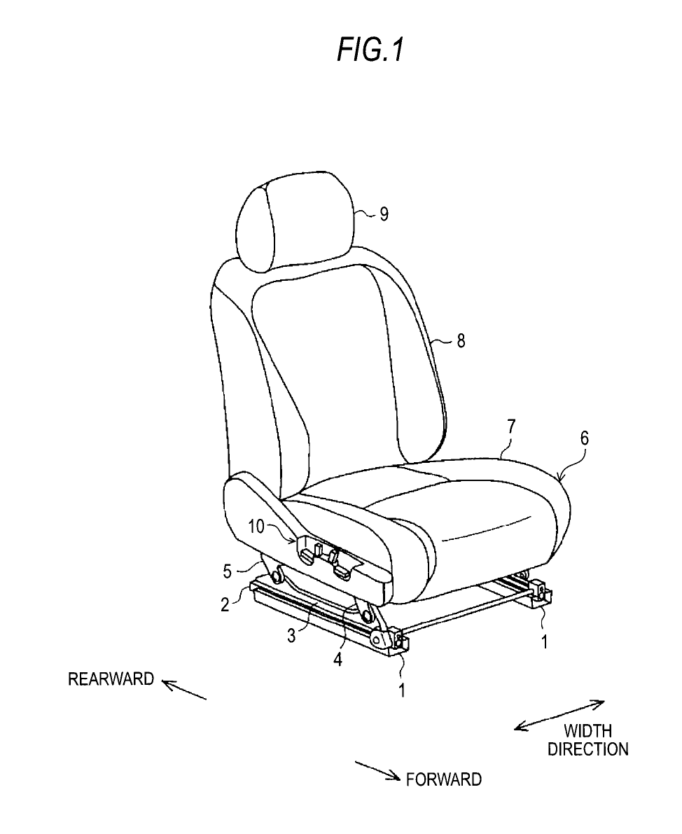

As illustrated in FIG. 1, a pair of lower rails 1 which are arranged side by side in a width direction of a seat and extend in a front-back direction are fixed to the floor of a vehicle, and an upper rail 2 is movably mounted on each of the two lower rails 1 in the front-back direction.

A bracket 3 made with a plate member stands on each of the two upper rails 2. A seat 6 forming a seating portion for an occupant is supported by each of the two brackets 3 via a front link 4 and a rear link 5 which are respectively arranged in the front portion and the rear portion. The seat 6 is configured to include a seat cushion 7 forming a seating surface, a seatback 8 tiltably (turnably) supported by a rear end portion of the seat cushion 7, and a headrest 9 supported by an upper end portion of the seatback 8.

A front-back position of the seat 6 is adjustable by relatively moving the lower rails 1 and the upper rails 2 on both sides, and a vertical position thereof is adjustable by lifting and lowering the front links 4 and the rear links 5 on both sides. In the seat 6, a tilt angle of the front portion of the seat cushion 7 is adjustable with respect to the rear portion thereof, and a tilt angle of the seatback 8 is adjustable with respect to the seat cushion 7. Accordingly, a person sitting on the seat 6 can adjust a position of an eye level in accordance with one's physical stature, for example.

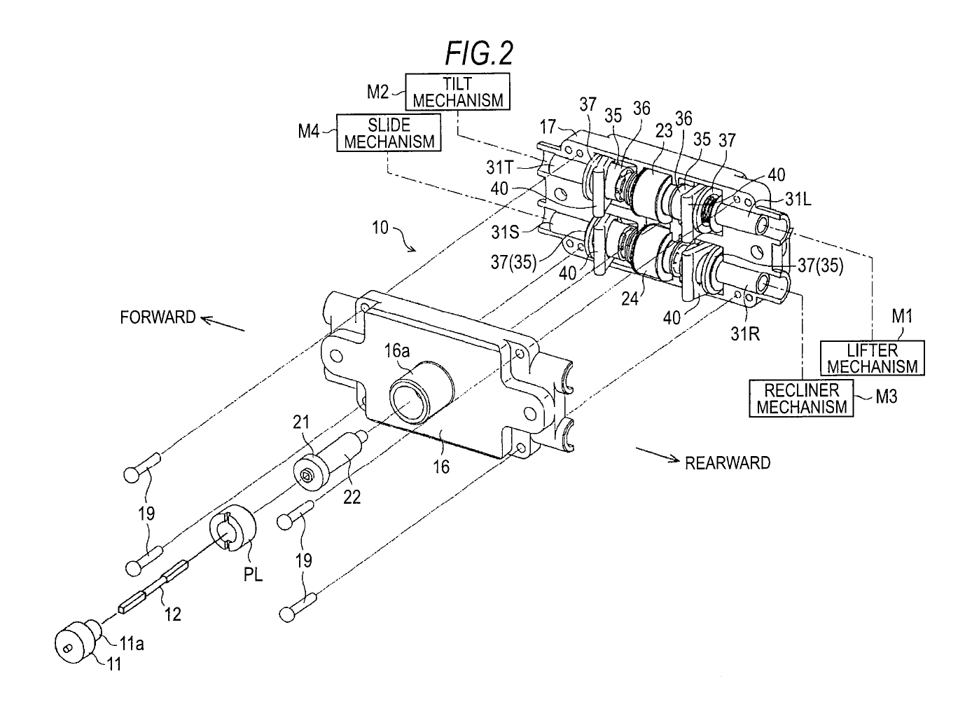

A driving apparatus 10 is attached to a side portion on one side of the seat cushion 7 (on the right side toward the front of the seat). As illustrated in FIG. 2, the driving apparatus 10 is joined to a rotary axis 11a of a rotary motor 11 configured to be a brush motor, for example, of which the axial line extends in substantially the width direction of the seat, so as to be driven therewith, via an input torque cable 12 which is coaxial with the rotary axis 11a.

In detail, the driving apparatus 10 includes a pair of main body cases 16 and 17 which are split into halves in an axial line direction of the rotary axis 11a. The main body cases 16 and 17 are fastened with four screws 19 which penetrate four corners of the main body cases in parallel to the axial line direction of the rotary axis 11a.

A substantially cylindrical holding portion 16a which is concentric with the input torque cable 12 (the rotary axis 11a) protrudes from a main body case 16 on the rotary motor 11 side. Inside the holding portion 16a, an annular bearing 21 is fitted and a substantially cylindrical bottomed plug PL is screwed thereto. A base end portion of a worm 22 disposed coaxially with the input torque cable 12 is pivotally supported by the bearing 21. The worm 22 is joined to the input torque cable 12 inserted through the plug PL, at the base end portion of the worm 22 so as to integrally rotate therewith. A distal end portion of the worm 22 is pivotally supported by a main body case 17 on a side away from the rotary motor 11.

A pair of worm wheels 23 and 24 of which axial lines respectively extend in the front-back direction on an upper side and a lower side of the worm 22 are arranged in the main body cases 16 and 17. The worm wheels 23 and 24 mesh with the worm 22 at skew positions differing from each other with respect to the worm 22. The worm wheels 23 and 24 are mutually set at an equivalent reduction ratio of 1 or greater.

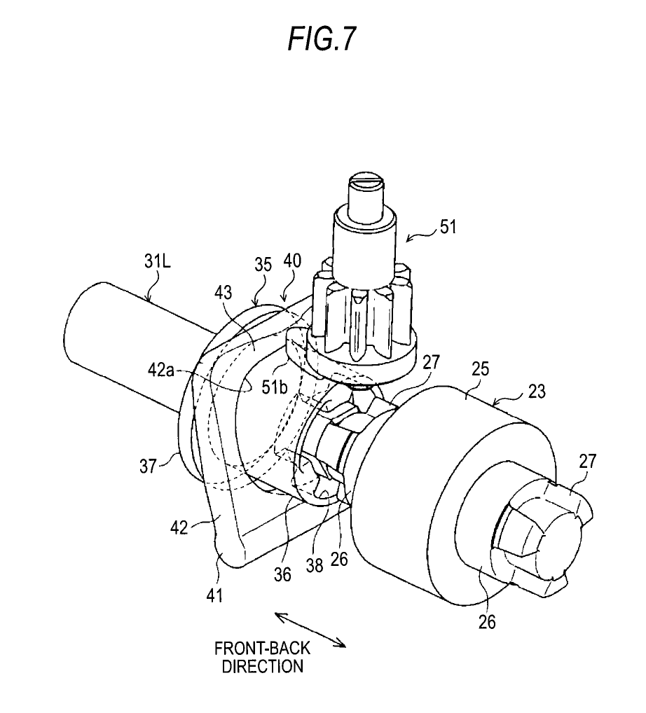

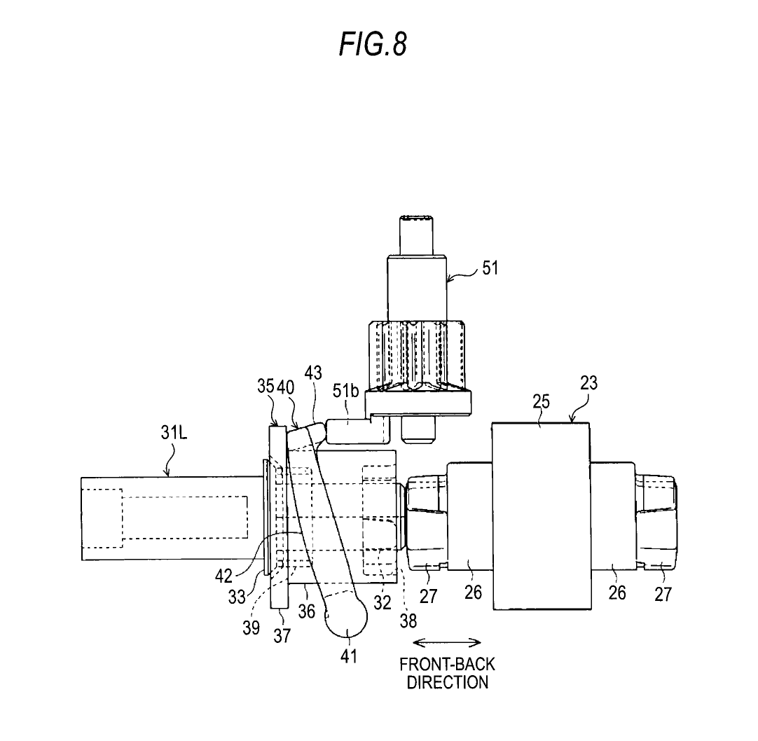

As collectively illustrated in FIGS. 7 and 8, one worm wheel 23 includes a gear portion 25 which meshes with the worm 22 on its upper side, includes a pair of shaft portions 26 protruding on the rear side and the front side of the gear portion 25 so as to be pivotally supported by the main body cases 16 and 17, and includes a pair of fitting portions 27 protruding respectively on the rear side and the front side of the two shaft portions 26. The outer shape of each fitting portion 27 exhibits a substantially three-vane shape in which a columnar shape and three arc columnar shapes extending from the columnar shape in the radial direction at equivalent angle intervals are combined. The other worm wheel 24 is also configured to have the same configuration, and the gear portion 25 thereof meshes with the worm 22 on the lower side thereof.

As illustrated in FIG. 2, a lifter shaft 31L and a tilt shaft 31T are respectively and pivotally supported by the main body cases 16 and 17 on the rear side and the front side of the worm wheel 23 coaxially with the worm wheel 23 in postures symmetrical with each other. The lifter shaft 31L is linked to a lifter mechanism M1 which is the positional adjustment mechanism adjusting the vertical position of the seat 6. The tilt shaft 31T is linked to a tilt mechanism M2 which is the positional adjustment mechanism adjusting the tilt angle of the front portion of the seat cushion 7 with respect to the rear portion thereof.

Moreover, a recliner shaft 31R and a slide shaft 31S are respectively and pivotally supported by the main body cases 16 and 17 on the rear side and the front side of the worm wheel 24 coaxially with the worm wheel 24 in postures symmetrical with each other. The recliner shaft 31R is linked to a recliner mechanism M3 which is the positional adjustment mechanism adjusting the tilt angle of the seatback 8 with respect to the seat cushion 7. The slide shaft 31S is linked to a slide mechanism M4 which is the positional adjustment mechanism adjusting the front-back position of the seat 6.

Therefore, when any one of the lifter shaft 31L, the tilt shaft 31T, the recliner shaft 31R, and the slide shaft 31S turns, the corresponding lifter mechanism M1, tilt mechanism M2, recliner mechanism M3, or slide mechanism M4 is activated, thereby being adjusted to the intended seat position. In other words, in the embodiment, the seat position can be adjusted in the forward direction and the reverse direction in each of the lifter mechanism M1, the tilt mechanism M2, the recliner mechanism M3, and the slide mechanism M4, that is, a so-called eight-way power seat.

The lifter shaft 31L, the tilt shaft 31T, the recliner shaft 31R, and the slide shaft 31S have the same structure except for their disposition states and the like. Therefore, the peripheral structure of the lifter shaft 31L will be described below as being representative.

As illustrated in FIGS. 7 and 8, the lifter shaft 31L exhibits a substantially columnar shape, and the distal end portion of the lifter shaft 31L extending from a bearing portion of the main body cases 16 and 17 to a side facing the worm wheel 23 forms an output shaft side fitting portion 32. The lifter shaft 31L also includes an outward flange 33 protruding in an intermediate portion in the axial line direction adjacent to the bearing portion of the main body cases 16 and 17.

A tubular member 35 is interposed between the fitting portion 27 of the worm wheel 23 and the flange 33 of the lifter shaft 31L. The tubular member 35 includes a tubular portion 36 and a flange-shaped pressing piece 37 protruding outward in the radial direction from the distal end facing the lifter shaft 31L of the tubular portion 36. The output shaft side fitting portion 32 is fitted into the tubular member 35 so as to integrally rotate with the lifter shaft 31L and to be movable in the axial line direction with respect to the lifter shaft 31L. A fitting hole 38 which can house the fitting portion 27 is formed in the tubular member 35. The tubular member 35 moves to the worm wheel 23 side in the axial line direction, thereby causing the fitting hole 38 to house the fitting portion 27 so as to integrally rotate with the worm wheel 23.

In other words, rotational force of the worm wheel 23 can be transmitted to the lifter shaft 31L via the tubular member 35 as the fitting portion 27 fits in the fitting hole 38 in response to the movement of the tubular member 35. As a fitted state between the fitting portion 27 and the fitting hole 38 is released, rotational force thereof cannot be transmitted to the lifter shaft 31L via the tubular member 35. The lifter mechanism M1 is activated in response to the turning of the lifter shaft 31L as described above. The fitting portion 27 of the worm wheel 23, and the output shaft side fitting portion 32 and the tubular member 35 of the lifter shaft 31L configure the clutch mechanism which selectively connects the worm wheel 23 and the lifter shaft 31L.

The output shaft side fitting portion 32 of the lifter shaft 31L is inserted through a compression spring 39 formed with a coil spring which is interposed between the tubular member 35 and the flange 33 on an inner circumferential side of the pressing piece 37. The tubular member 35 is biased at all times to a side in which the fitting hole 38 houses in the fitting portion 27 of the worm wheel 23 due to the compression spring 39, that is, a side in which rotational force of the worm wheel 23 can be transmitted to the lifter shaft 31L. In other words, in a state where rotational force of the worm wheel 23 cannot be transmitted to the lifter shaft 31L, the tubular member 35 moves to a side in which a fitting state between the fitting portion 27 and the fitting hole 38 is released against biasing force of the compression spring 39.

The same clutch mechanism is configured between the worm wheel 23 and the tilt shaft 31T, between the worm wheel 24 and the recliner shaft 31R, and between the worm wheel 24 and the slide shaft 31S so as to selectively connect them with each other.

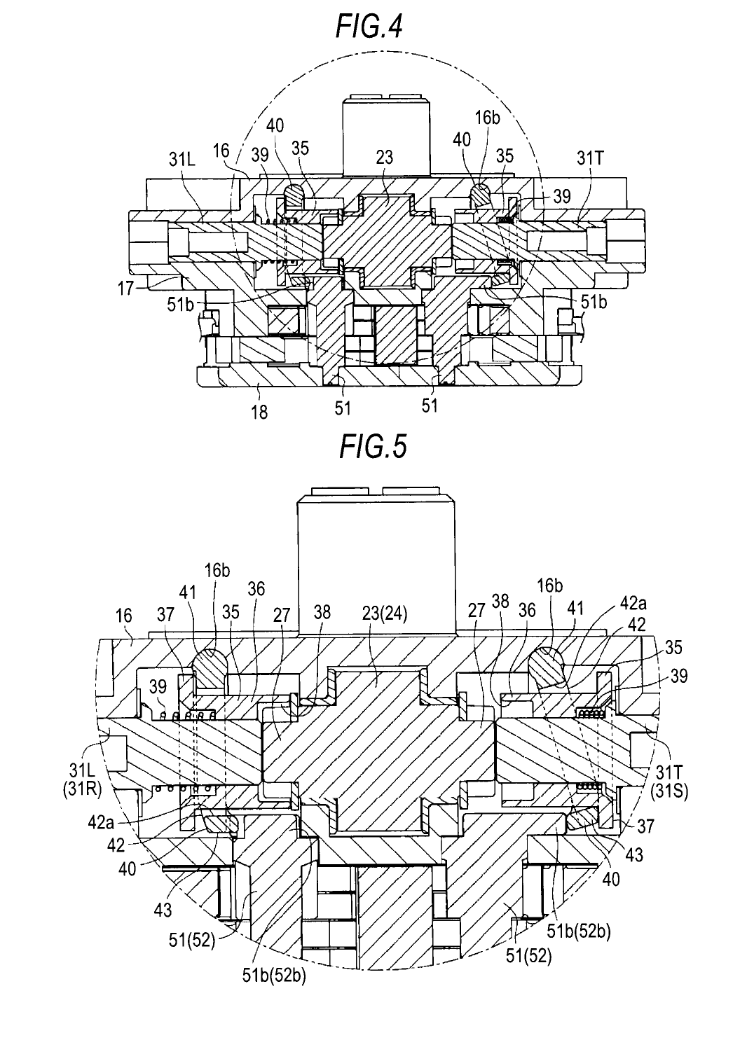

The tubular portion 36 of each tubular member 35 is loosely inserted into an intermediary member 40 which is supported by the main body case 16. In other words, as illustrated in FIGS. 4 and 5, a substantially semicircular groove-shaped bearing groove 16b extending in a vertical direction (a direction orthogonal to the drawing sheet) between the pressing piece 37 of the tubular member 35 and the worm wheel 23 (24) which are adjacent to each other is formed in the main body case 16.

Meanwhile, the intermediary member 40 includes a substantially superior arc columnar shaft portion 41 which is pivotally supported by the bearing groove 16b and includes a substantially square frame-shaped main body portion 42 crossing the tubular portion 36 of the tubular member 35 in a direction substantially orthogonal to the axial line direction. In the intermediary member 40, the tubular portion 36 is loosely inserted into a substantially circular insertion through hole 42a formed in the main body portion 42. Therefore, the intermediary member 40 can turn about the bearing groove 16b in a certain range without being hindered by the tubular portion 36. The circumferential direction of this turning range is along movement direction of the tubular member 35 coinciding with the axial line direction thereof.

As illustrated on the left side in FIG. 5, when the main body portion 42 of the intermediary member 40 is widened along the pressing piece 37 of the tubular member 35, the tubular member 35 is biased by the compression spring 39, thereby causing the fitting hole 38 to house the fitting portion 27 of the worm wheel 23 (24). Meanwhile, as illustrated on the right side in FIG. 5, when the main body portion 42 of the intermediary member 40 turns in a direction away from the worm wheel 23 (24) centering around the shaft portion 41, the tubular member 35 of the pressing piece 37 pressed by the main body portion 42 moves in the axial line direction against biasing force of the compression spring 39, thereby releasing the fitting hole 38 from the fitting portion 27 of the worm wheel 23 (24).

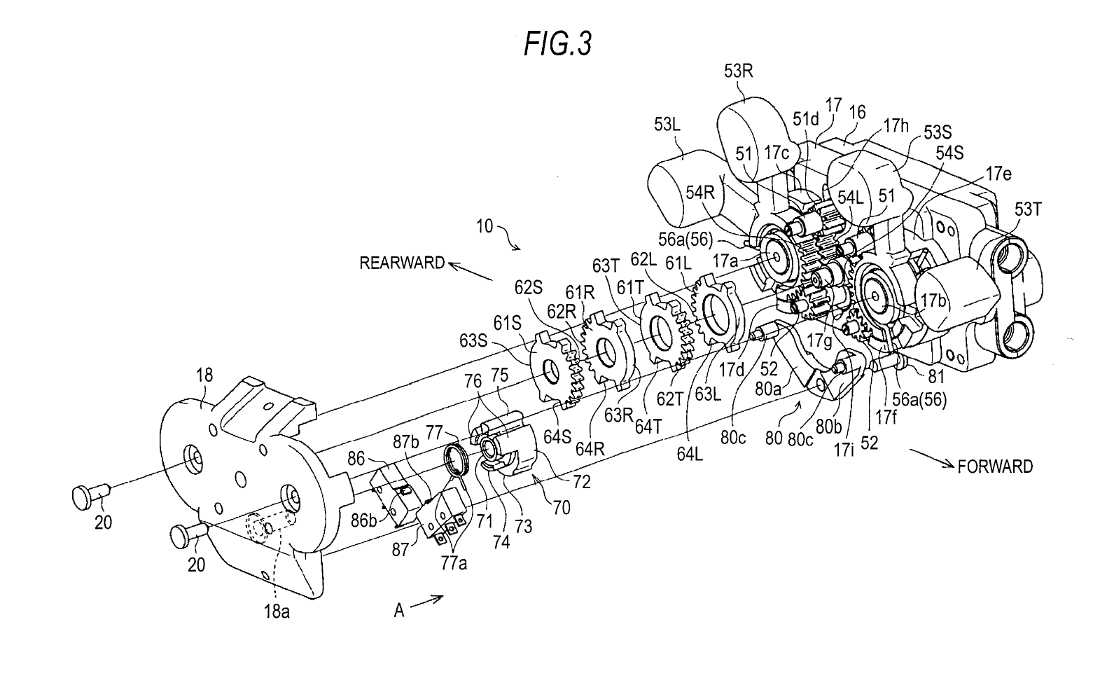

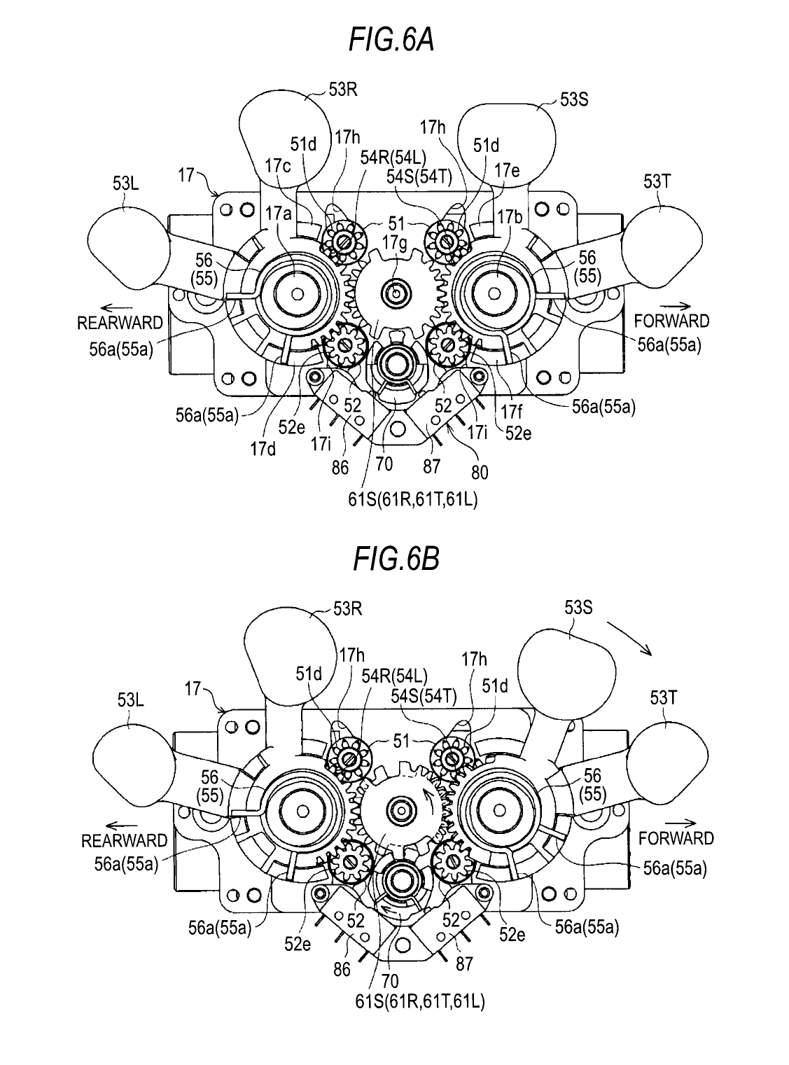

As illustrated in FIGS. 3, 6A, and 6B, a pair of support axis portions 17a and 17b arranged side by side in the front-back direction protrude in the main body case 17 toward the opposite side of the main body case 16 side by side in the axial line direction of the worm 22 (the rotary axis 11a). In the main body case 17, substantially arc columnar guide portions 17c and 17d protrude on the upper side and the lower side of the support axis portion 17a concentric therewith, and substantially arc columnar guide portions 17e and 17f protrude on the upper side and the lower side of the support axis portion 17b concentric therewith. In the main body case 17, a switch cam support axis portion (the first rotary axis) 17g concentric with the worm 22 protrudes toward the opposite side of the main body case 16. The center of the switch cam support axis portion 17g is disposed in the center between the two support axis portions 17a and 17b.

In the main body case 17, substantially circular bearing holes 17h and 17i are respectively formed on the upper side and the lower side between the support axis portion 17a and the switch cam support axis portion 17g. The same bearing holes 17h and 17i are respectively formed on the upper side and the lower side between the support axis portion 17b and the switch cam support axis portion 17g. A pair of first cam members 51 are respectively and pivotally supported by the two bearing holes 17h on the upper side, and a pair of second cam members 52 are respectively and pivotally supported by the two bearing holes 17i on the lower side.

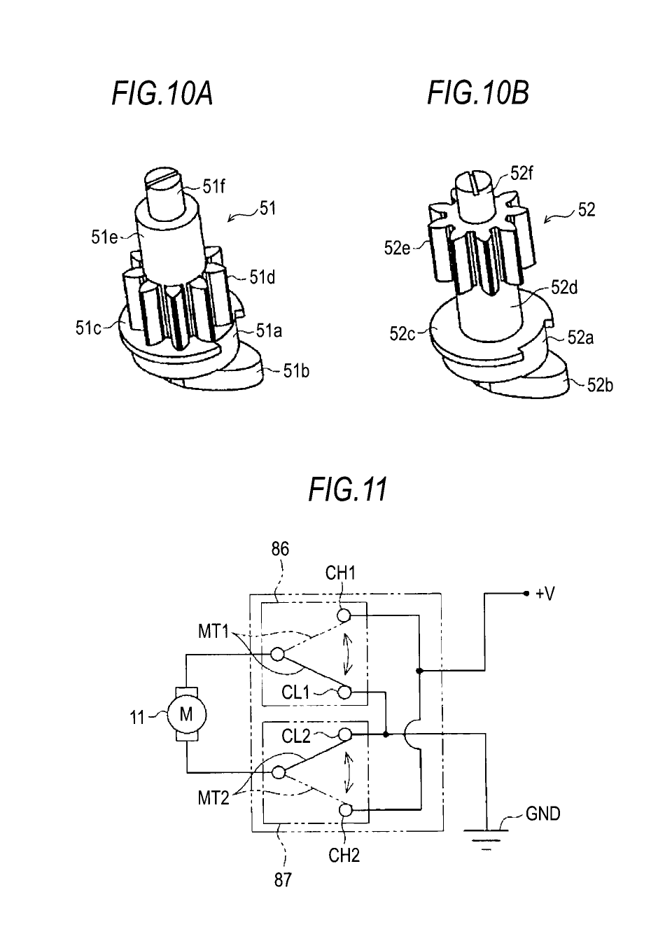

As illustrated in FIG. 10A, the first cam member 51 includes a substantially columnar large diameter shaft portion 51a which is pivotally supported by the bearing hole 17h, includes a substantially oval cam portion 51b which protrudes inside the main body case 17 from the bearing hole 17h, and includes a flange portion 51c which protrudes toward the outside of the main body case 17 from the bearing hole 17h and comes into sliding contact with an outer circumferential edge portion of the bearing hole 17h. The first cam member 51 includes a gear portion 51d which is adjacent to the flange portion 51c and is disposed outside the main body case 17, includes a columnar portion 51e which is adjacent to the gear portion 51d and is disposed farther outside the main body case 17, and includes a substantially columnar small diameter shaft portion 51f which is decreased in diameter more than that of the columnar portion 51e.

As illustrated in FIGS. 7 and 8, in the first cam member 51 on the lifter shaft 31L side, the cam portion 51b is disposed so as to cause the cam portion 51b to be able to come into contact with a distal end portion 43 of the intermediary member 40 on a side away from the shaft portion 41 and to come into contact with or to approach the outer circumferential surface of the tubular portion 36 of the tubular member 35. In other words, the first cam member 51 causes the cam portion 51b to press the pressing piece 37 of the tubular member 35 via the intermediary member 40. When a longitudinal direction of the cam portion 51b extends in a rotary position to coincide with the axial line direction of the tubular member 35 and the like, that is, the rotary position in which the tubular member 35 is caused to be farthest away from the worm wheel 23 (hereinafter, also referred to as “a neutral position” of the first cam member 51), the fitting hole 38 of the tubular member 35 is released from the fitting portion 27 of the worm wheel 23 against biasing force of the compression spring 39.

As illustrated on the left side in FIG. 5, when the longitudinal direction of the cam portion 51b is deviated from the axial line direction of the tubular member 35 and the like in response to the turning thereof, the first cam member 51 allows movement of the tubular member 35 so as to cause the fitting hole 38 of the tubular member 35 biased by the compression spring 39 to house the fitting portion 27 of the worm wheel 23. Meanwhile, the first cam member 51 presses the pressing piece 37 of the tubular member 35 with the cam portion 51b via the intermediary member 40 in response to the turning toward the neutral position, thereby moving the tubular member 35 against biasing force of the compression spring 39 and releasing the fitting hole 38 of the tubular member 35 from the fitting portion 27 of the worm wheel 23. The first cam member 51 on the tilt shaft 31T side is operated in the same manner.

Meanwhile, as illustrated in FIG. 10B, the second cam member 52 includes a substantially columnar large diameter shaft portion 52a which is pivotally supported by the bearing hole 17i, includes a substantially oval cam portion 52b which protrudes inside the main body case 17 from the bearing hole 17i, and includes a flange portion 52c which protrudes toward the outside of the main body case 17 from the bearing hole 17i and comes into sliding contact with an outer circumferential edge portion of the bearing hole 17i. The second cam member 52 includes a columnar portion 52d which is adjacent to the flange portion 52c and is disposed outside the main body case 17, includes a gear portion 52e which is adjacent to the columnar portion 52d and is disposed farther outside the main body case 17, and includes a substantially columnar small diameter shaft portion 52f which is decreased in diameter more than that of the columnar portion 52d. In other words, the first and second cam members 51 and 52 mutually have the same shape except that the gear portions 51d and 52e and the columnar portions 51e and 52d are alternately disposed in the axial line direction.

In the second cam member 52 on the recliner shaft 31R side, the cam portion 52b is disposed so as to cause the cam portion 52b to be able to come into contact with the distal end portion 43 of the intermediary member 40 on a side away from the shaft portion 41 and to come into contact with or to approach the outer circumferential surface of the tubular portion 36 of the tubular member 35. In other words, the second cam member 52 causes the cam portion 52b to press the pressing piece 37 of the tubular member 35 via the intermediary member 40. When the longitudinal direction of the cam portion 52b extends in the rotary position to coincide with the axial line direction of the tubular member 35 and the like, that is, the rotary position in which the tubular member 35 is caused to be farthest away from the worm wheel 24 (hereinafter, also referred to as “a neutral position” of the second cam member 52), the fitting hole 38 of the tubular member 35 is released from the fitting portion 27 of the worm wheel 24 against biasing force of the compression spring 39.

When the longitudinal direction of the cam portion 52b is deviated from the axial line direction of the tubular member 35 and the like in response to the turning thereof, the second cam member 52 allows movement of the tubular member 35 so as to cause the fitting hole 38 of the tubular member 35 biased by the compression spring 39 to house the fitting portion 27 of the worm wheel 24. Meanwhile, the second cam member 52 presses the pressing piece 37 of the tubular member 35 with the cam portion 52b via the intermediary member 40 in response to the turning toward the neutral position, thereby moving the tubular member 35 against biasing force of the compression spring 39 and releasing the fitting hole 38 of the tubular member 35 from the fitting portion 27 of the worm wheel 24. The second cam member 52 on the slide shaft 31S side is operated in the same manner.

As illustrated in FIGS. 3, 6A, and 6B, a lifter operation handle 53L as the operation member is pivotally supported by a base end portion of the support axis portion 17a. The lifter operation handle 53L meshes with the gear portion 51d of the first cam member 51 and includes a gear portion 54L idling at a position of the columnar portion 52d of the second cam member 52. Therefore, for example, when the lifter operation handle 53L is in turning operation, the first cam member 51 (the cam portion 51b) turns in accordance with rotational force transmitted from between the gear portions 54L and 51d. Accordingly, the tubular member 35 moves in the axial line direction in the above-described state.

A torsion spring 55 is wound about the support axis portion 17a which is the inner circumferential side of the lifter operation handle 53L. The proximal end portions of hook portions 55a at both ends of the torsion spring 55 come into contact with a stopper portion of the lifter operation handle 53L so as to be wheel-locked, and the distal end portions of the hook portions 55a are positioned by the guide portions 17c and 17d. The lifter operation handle 53L is biased by the torsion spring 55, thereby being held in a predetermined initial position extending toward the rear of the support axis portion 17a. In this case, the first cam member 51 which integrally turns with the lifter operation handle 53L is set so as to be disposed at the neutral position. The biasing force of the torsion spring 55 holding the lifter operation handle 53L at the initial position is set to be greater than the biasing force of the compression spring 39 which moves the tubular member 35 so as to cause the fitting hole 38 of the tubular member 35 to house the fitting portion 27 of the worm wheel 23.

Therefore, normally, the lifter operation handle 53L is held at the initial position. In accordance therewith, the first cam member 51 is disposed at the neutral position. In other words, normally, the worm wheel 23 and the lifter shaft 31L are held in a state so as not to be able to transmit rotational force therebetween via the tubular member 35. When the lifter operation handle 53L is in turning operation against biasing force of the torsion spring 55, the first cam member 51 is deviated from the neutral position due to turning of the first cam member 51 caused by the turning operation of the lifter operation handle 53L, and then, the tubular member 35 moves so as to cause the fitting hole 38 of the tubular member 35 to house the fitting portion 27 of the worm wheel 23 due to biasing force of the compression spring 39. Accordingly, rotational force of the worm wheel 23 can be transmitted to the lifter shaft 31L via the tubular member 35.

A recliner operation handle 53R as the operation member is pivotally supported by the distal end portion of the support axis portion 17a. The recliner operation handle 53R meshes with the gear portion 52e of the second cam member 52 and includes a gear portion 54R idling at a position of the columnar portion 51e of the first cam member 51. Therefore, for example, when the recliner operation handle 53R is in turning operation, the second cam member 52 (the cam portion 52b) turns in accordance with rotational force transmitted from between the gear portions 54R and 52e. Accordingly, the tubular member 35 moves in the axial line direction in the above-described state.

A torsion spring 56 is wound about the support axis portion 17a which is the inner circumferential side of the recliner operation handle 53R. The proximal end portions of hook portions 56a at both ends of the torsion spring 56 come into contact with a stopper portion of the recliner operation handle 53R so as to be wheel-locked, and the distal end portions of the hook portions 56a are positioned by the guide portions 17c and 17d. The recliner operation handle 53R is biased by the torsion spring 56, thereby being held in a predetermined initial position extending toward the upper portion of the support axis portion 17a. In this case, the second cam member 52 which integrally turns with the recliner operation handle 53R is set so as to be disposed at the neutral position. The biasing force of the torsion spring 56 holding the recliner operation handle 53R at the initial position is set to be greater than the biasing force of the compression spring 39 which moves the tubular member 35 so as to cause the fitting hole 38 of the tubular member 35 to house the fitting portion 27 of the worm wheel 24.

Therefore, normally, the recliner operation handle 53R is held at the initial position. In accordance therewith, the second cam member 52 is disposed at the neutral position. In other words, normally, the worm wheel 24 and the recliner shaft 31R are held in a state so as not to be able to transmit rotational force therebetween via the tubular member 35. When the recliner operation handle 53R is in turning operation against biasing force of the torsion spring 56, the second cam member 52 is deviated from the neutral position due to turning of the second cam member 52 caused by the turning operation of the recliner operation handle 53R, and then, the tubular member 35 moves so as to cause the fitting hole 38 of the tubular member 35 to house the fitting portion 27 of the worm wheel 24 due to biasing force of the compression spring 39. Accordingly, rotational force of the worm wheel 24 can be transmitted to the recliner shaft 31R via the tubular member 35.

Meanwhile, a tilt operation handle 53T as the operation member is pivotally supported by the base end portion of the support axis portion 17b. The tilt operation handle 53T meshes with the gear portion 51d of the first cam member 51 and includes a gear portion 54T idling at a position of the columnar portion 52d of the second cam member 52. The operation of the tilt operation handle 53T is the same as the operation of the lifter operation handle 53L. In other words, normally, the worm wheel 23 and the tilt shaft 31T are held in a state so as not to be able to transmit rotational force therebetween via the tubular member 35. When the tilt operation handle 53T is in turning operation against biasing force of the torsion spring 55, the first cam member 51 is deviated from the neutral position due to turning of the first cam member 51 caused by the turning operation of the tilt operation handle 53T, and then, the tubular member 35 moves so as to cause the fitting hole 38 of the tubular member 35 to house the fitting portion 27 of the worm wheel 23 due to biasing force of the compression spring 39. Accordingly, rotational force of the worm wheel 23 can be transmitted to the tilt shaft 31T via the tubular member 35.

A slide operation handle 53S as the operation member is pivotally supported by the distal end portion of the support axis portion 17b. The slide operation handle 53S meshes with the gear portion 52e of the second cam member 52 and includes a gear portion 54S idling at a position of the columnar portion 51e of the first cam member 51. The operation of the slide operation handle 53S is the same as the operation of the recliner operation handle 53R. In other words, normally, the worm wheel 24 and the slide shaft 31S are held in a state so as not to be able to transmit rotational force therebetween via the tubular member 35. When the slide operation handle 53S is in turning operation against biasing force of the torsion spring 56, the second cam member 52 is deviated from the neutral position due to turning of the second cam member 52 caused by the turning operation of the slide operation handle 53S, and then, the tubular member 35 moves so as to cause the fitting hole 38 of the tubular member 35 to house the fitting portion 27 of the worm wheel 24 due to biasing force of the compression spring 39. Accordingly, rotational force of the worm wheel 24 can be transmitted to the slide shaft 31S via the tubular member 35.

As illustrated in FIG. 3, a lifter switch cam member 61L, a tilt switch cam member 61T, a recliner switch cam member 61R, and a slide switch cam member 61S are pivotally supported as the plurality of substantially annular switch cam members in the switch cam support axis portion 17g, in order from the base end to the distal end.

The lifter switch cam member 61L is formed in the outer circumferential portion on a side facing the gear portion 54L of the lifter operation handle 53L, includes a gear portion 62L meshing therewith, and also includes an arc portion 63L formed in the outer circumferential portion on a side facing the gear portion 54T of the tilt operation handle 53T so as to be idling therein. Therefore, for example, when the lifter operation handle 53L is in turning operation, the lifter switch cam member 61L idles in the gear portion 54T of the tilt operation handle 53T in the arc portion 63L and turns in accordance with rotational force transmitted from between the gear portions 54L and 62L.

The tilt switch cam member 61T is formed in the outer circumferential portion on a side facing the gear portion 54T of the tilt operation handle 53T, includes a gear portion 62T meshing therewith, and also includes an arc portion 63T formed in the outer circumferential portion on a side facing the gear portion 54L of the lifter operation handle 53L so as to be idling therein. Therefore, for example, when the tilt operation handle 53T is in turning operation, the tilt switch cam member 61T idles in the gear portion 54L of the lifter operation handle 53L in the arc portion 63T and turns in accordance with rotational force transmitted from between the gear portions 54T and 62T.

The recliner switch cam member 61R is formed in the outer circumferential portion on a side facing the gear portion 54R of the recliner operation handle 53R, includes a gear portion 62R meshing therewith, and also includes an arc portion 63R formed in the outer circumferential portion on a side facing the gear portion 54S of the slide operation handle 53S so as to be idling therein. Therefore, for example, when the recliner operation handle 53R is in turning operation, the recliner switch cam member 61R idles in the gear portion 54S of the slide operation handle 53S in the arc portion 63R and turns in accordance with rotational force transmitted from between the gear portions 54R and 62R.

The slide switch cam member 61S is formed in the outer circumferential portion on a side facing the gear portion 54S of the slide operation handle 53S, includes a gear portion 62S meshing therewith, and also includes an arc portion 63S formed in the outer circumferential portion on a side facing the gear portion 54R of the recliner operation handle 53R so as to be idling therein. Therefore, for example, when the slide operation handle 53S is in turning operation, the slide switch cam member 61S idles in the gear portion 54R of the recliner operation handle 53R in the arc portion 63S and turns in accordance with rotational force transmitted from between the gear portions 54S and 62S.

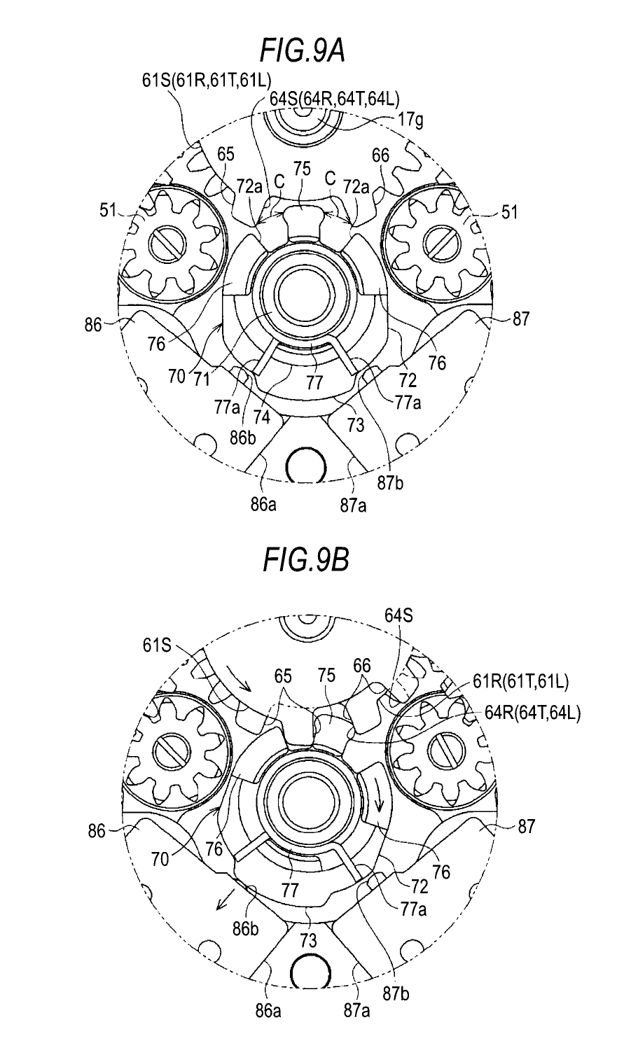

The lifter switch cam member 61L, the tilt switch cam member 61T, the recliner switch cam member 61R, and the slide switch cam member 61S respectively form the switch cam portions 64L, 64T, 64R, and 64S at the lower portion of the outer circumferential portion interposed between the gear portions 62L, 62T, 62R, and 62S and the arc portions 63L, 63T, 63R, and 63S. As illustrated in FIG. 9A, both end portions of each of the switch cam portions 64L, 64T, 64R, and 64S in the circumferential direction respectively form a pair of pressing portions 65 and 66 protruding downward in substantially claw shapes.

As illustrated in FIG. 3, the driving apparatus 10 includes a cover 18 forming a casing thereof, in addition to the main body cases 16 and 17. The cover 18 is fastened to the main body case 17 as two screws 20 penetrating the cover 18 in parallel to the axial line direction of the rotary axis 11a are respectively fastened to the two support axis portions 17a and 17b in a state of covering the main body case 17 from outside. Accordingly, the operation handles 53L, 53T, 53R, and 53S are positioned in the axial line direction. In this case, as the distal end of the switch cam support axis portion 17g fits the cover 18, the switch cam members 61L, 61T, 61R, and 61S are positioned in the axial line direction. Moreover, each of the first cam member 51 and the second cam member 52 is positioned in the axial line direction as the small diameter shaft portions 51f and 52f are pivotally supported by the cover 18.

A switch support axis portion (a second rotary axis) 18a including the axial line extending on the lower side of the switch cam support axis portion 17g to be in parallel to the axial line thereof protrudes from the cover 18. As collectively illustrated in FIG. 9A, a switch lever 70 disposed at the lower side of the switch cam portions 64L, 64T, 64R, and 64S is supported by the switch support axis portion 18a. The switch lever 70 exhibits a bilaterally symmetrical shape, includes a substantially cylindrical bearing portion 71 which is pivotally supported by the switch support axis portion 18a, and includes a flange 72 extending outward from the end portion on a side away from the cover 18 of the bearing portion 71. A substantially fan-shaped columnar switch pressing portion 73 protruding downward is formed in the flange 72. In the lower end portion of the flange 72, a substantially arc columnar stopper piece 74 protrudes toward the cover 18 above the switch pressing portion 73 in parallel to the bearing portion 71. Moreover, substantially U-shaped notches 72a recessed toward the turning center from two angle positions interposing the upper end are formed in the flange 72. The switch lever 70 includes a substantially square columnar pressed portion 75 which is connected to the flange 72 at an angle position at the upper end interposed between the two notches 72a. The switch lever 70 also includes a pair of substantially fan-shaped columnar regulation portions 76 respectively connected to the flange 72 at two angle positions adjacent to the two notches 72a. The pressed portion 75 and the two regulation portions 76 are positioned on a farther outer circumferential side than the bearing portion 71, and the length thereof in the axial line direction is set to be equivalent to the length of all of the switch cam members 61L, 61T, 61R, and 61S in the axial line direction in a state of being superposed. In other words, the pressed portion 75 and the two regulation portions 76 extend along the direction so as to cover the positions of all of the switch cam members 61L, 61T, 61R, and 61S (pressing portions 65 and 66) in the axial line direction.

A return spring 77 configured to be a torsion spring, for example, is wound about the bearing portion 71 which is on a farther inner circumferential side than the stopper piece 74 and the like. The proximal end portions of the hook portions 77a at both ends of the return spring 77 come into contact with the stopper piece 74 so as to be wheel-locked, and the distal end portions of the hook portions 77a are positioned at an engagement wall (not illustrated) of the cover 18. As the switch lever 70 is biased by the return spring 77, the pressed portion 75 is held at a predetermined initial turning position (the neutral position) extending upward.

Here, as illustrated in FIGS. 6A and 9A, it is considered that all of the operation handles 53L, 53T, 53R, and 53S are not in operation and are disposed at a corresponding predetermined initial position. In this case, the pressed portion 75 of the switch lever 70 disposed at the initial turning position is disposed so as to block the turning track about the switch cam support axis portion 17g of the two pressing portions (first and second pressing portions) 65 and 66 of all of the switch cam members 61L, 61T, 61R, and 61S. The pressed portion 75 is disposed at the central portion interposed between the two pressing portions 65 and 66 of all of the switch cam members 61L, 61T, 61R, and 61S. The pressed portion 75 forms a clearance gap C between the pressing portions 65 and 66 in the circumferential direction centering around the switch support axis portion 18a. Meanwhile, the two regulation portions 76 of the switch lever 70 are disposed so as to open the turning track about the switch cam support axis portion 17g of the pressing portions 65 and 66 in a state where the distal ends of the two regulation portions 76 respectively approach the distal ends of the two pressing portions 65 and 66 of all of the switch cam members 61L, 61T, 61R, and 61S.

As illustrated in the changes shifted to those in FIGS. 6B and 9B, the slide switch cam member 61S (a switch cam portion 64S) is caused to turn counterclockwise by performing a clockwise turning operation of the slide operation handle 53S, for example. In this case, the slide switch cam member 61S presses the pressed portion 75 of the switch lever 70 with the corresponding pressing portion 65 passing through a free running section of the clearance gap C on the left side in the drawing. Accordingly, when the switch lever 70 turns clockwise as illustrated centering around the switch support axis portion 18a, the pressed portion 75 passes through the free running section of the clearance gap C between the pressed portion 75 and the pressing portion 66 of each of other preceding switch cam members 61R, 61T, and 61L (the switch cam portions 64R, 64T, and 64L) in the turning direction of the pressed portion 75, thereby coming into contact with or approaching the pressing portion 66. In other words, on account of the clearance gap C present on the right side in FIG. 9A, even though the switch lever 70 turns in response to the counterclockwise turning of the slide switch cam member 61S as illustrated, the pressed portion 75 is prevented from pressing the pressing portion 66 of other switch cam members 61R, 61T, and 61L and causing the same to turn counterclockwise as illustrated. Moreover, in accordance with the pressed portion 75 of the switch lever 70 coming into contact with or approaching the pressing portion 66 of other switch cam members 61R, 61T, and 61L, the turning track about the switch cam support axis portion 17g of the pressing portion 66 is blocked, thereby regulating counterclockwise turning of other switch cam members 61R, 61T, and 61L as illustrated.

Simultaneously, one (on the left side in the drawing) regulation portion 76 following the pressed portion 75 in the turning direction of the switch lever 70 blocks the turning track about the switch cam support axis portion 17g of the pressing portion 65 adjacent to the regulation portion 76 of other switch cam members 61R, 61T, and 61L (the switch cam portions 64R, 64T, and 64L). Accordingly, clockwise turning of other switch cam members 61R, 61T, and 61L as illustrated in the drawing is regulated.

In contrast, when the slide switch cam member 61S (the switch cam portion 64S) is caused to turn clockwise as illustrated in FIG. 9A by performing a counterclockwise turning operation of the slide operation handle 53S, the slide switch cam member 61S presses the pressed portion 75 of the switch lever 70 with the corresponding pressing portion 66 passing through the free running section of the clearance gap C on the right side in the drawing. Accordingly, when the switch lever 70 turns counterclockwise as illustrated centering around the switch support axis portion 18a, the pressed portion 75 passes through the free running section of the clearance gap C between the pressed portion 75 and the pressing portion 65 of each of other preceding switch cam members 61R, 61T, and 61L (the switch cam portions 64R, 64T, and 64L) in the turning direction of the pressed portion 75, thereby coming into contact with or approaching the pressing portion 65. In other words, on account of the clearance gap C present on the left side in FIG. 9A, even though the switch lever 70 turns in response to the clockwise turning of the slide switch cam member 61S as illustrated, the pressed portion 75 is prevented from pressing the pressing portion 65 of other switch cam members 61R, 61T, and 61L and causing the same to turn clockwise as illustrated. Moreover, in accordance with the pressed portion 75 of the switch lever 70 coming into contact with or approaching the pressing portion 65 of other switch cam members 61R, 61T, and 61L, the turning track about the switch cam support axis portion 17g of the pressing portion 65 is blocked, thereby regulating clockwise turning of other switch cam members 61R, 61T, and 61L as illustrated.

Simultaneously, one (on the right side in the drawing) regulation portion 76 following the pressed portion 75 in the turning direction of the switch lever 70 blocks the turning track about the switch cam support axis portion 17g of the pressing portion 66 adjacent to the regulation portion 76 of other switch cam members 61R, 61T, and 61L (the switch cam portions 64R, 64T, and 64L). Accordingly, counterclockwise turning of other switch cam members 61R, 61T, and 61L as illustrated in the drawing is regulated.

As described above, in a state where the slide switch cam member 61S turns in accordance with a turning operation of the slide operation handle 53S, turning of other switch cam members 61R, 61T, and 61L is regulated in both directions on account of cooperation of the pressed portion 75 and the regulation portion 76. The operation is the same in a case of a turning operation of other operation handles 53T, 53R, and 53S. In other words, in a case where a corresponding switch cam member among the switch cam members 61L, 61T, 61R, and 61S turns in accordance with a turning operation of any one of the operation handles 53L, 53T, 53R, and 53S, turning of other switch cam members among the switch cam members 61L, 61T, 61R, and 61S is regulated. Then, turning (oscillation) of other operation handles among the operation handles 53L, 53T, 53R, and 53S respectively joined to other switch cam members among the switch cam members 61L, 61T, 61R, and 61S so as to be driven therewith is regulated as well. In other words, during a turning operation of any one of the operation handles 53L, 53T, 53R, and 53S, possibility of turning of other operation handles among the operation handles 53L, 53T, 53R, and 53S decreases.

As illustrated in FIGS. 3, 6A, and 6B, a support frame 80 is disposed below the switch lever 70. The support frame 80 includes a pair of support pieces 80a and 80b opposing each other upwards from the lower end portion and being oriented in the front-back direction, and exhibits a substantially V-shape. In the upper end portion of each of the support pieces 80a and 80b, a joining protrusion portion 80c protrudes toward the cover 18 in parallel to the axial line direction of the support axis portions 17a and 17b and the like. The support frame 80 is supported by the cover 18 as a screw 81 penetrating the lower end portion in parallel to the axial line direction of the joining protrusion portion 80c and the like is fastened to the cover 18, and the distal ends of the two joining protrusion portions 80c are fitted to the cover 18.

The two support pieces 80a and 80b respectively support the first switch structure body 86 and the second switch structure body 87 configuring the switch structure bodies below the joining protrusion portion 80c. Each of the first switch structure body 86 and the second switch structure body 87 includes substantially rectangular column-shaped main body portions 86a and 87a extending in an extension direction of the two support pieces 80a and 80b, and includes buttons 86b and 87b which can be upwardly in and out from the top surface in which the main body portions 86a and 87a face each other. As collectively illustrated in FIG. 9A, the main body portions 86a and 87a are disposed so as to open the turning track centering around the switch support axis portion 18a of the switch pressing portion 73. Meanwhile, the buttons 86b and 87b are normally in a state of respectively protruding upwards from the top surfaces of the main body portions 86a and 87a, and are arranged side by side in the circumferential direction centering around the switch support axis portion 18a of the switch pressing portion 73. Then, the buttons 86b and 87b are normally disposed so as to block the turning track centering around the switch support axis portion 18a of the switch pressing portion 73. Therefore, as illustrated in the change shifted to that in FIG. 9B, for example, when the switch lever 70 turns clockwise centering around the switch support axis portion 18a, in accordance therewith, a button 86b of the first switch structure body 86 is pressed downward (outside in the radial direction centering around the switch support axis portion 18a) by the switch pressing portion 73. In contrast, when the switch lever 70 turns counterclockwise centering around the switch support axis portion 18a as in FIG. 9A, in accordance therewith, a button 87b of the second switch structure body 87 is pressed downward (outside in the radial direction centering around the switch support axis portion 18a) by the switch pressing portion 73.

As illustrated in FIG. 11, each of the first switch structure body 86 and the second switch structure body 87 includes an electric circuit which is configured to have contact points CH1 and CH2 electrically connected to a high potential +V of a DC power source, contact points CL1 and CL2 electrically connected to a low potential GND, and movable terminals MT1 and MT2 connected to terminals of the rotary motor 11 different from each other. The two movable terminals MT1 and MT2 are respectively coupled to the two buttons 86b and 87b and are electrically connected to the contact points CL1 and CL2 on the low potential GND side, normally. The two movable terminals MT1 and MT2 are electrically connected to the contact points CH1 and CH2 on the high potential +V side as the two buttons 86b and 87b are respectively pressed down. Therefore, when the switch lever 70 turns clockwise centering around the switch support axis portion 18a in accordance with a turning operation of any one of the operation handles 53L, 53T, 53R, and 53S, the movable terminal MT1 of the first switch structure body 86 of which the button 86b is pressed down is electrically connected to the contact point CH1 on the high potential +V side, thereby electrifying the rotary motor 11 through one polarity. In contrast, when the switch lever 70 turns counterclockwise centering around the switch support axis portion 18a, the movable terminal MT2 of the second switch structure body 87 of which the button 87b is pressed down is electrically connected to the contact point CH2 on the high potential +V side, thereby electrifying the rotary motor 11 through the opposite polarity.

In other words, the first switch structure body 86 and the second switch structure body 87 (the switch structure body) includes the switch which electrifies the rotary motor 11 through a polarity coping with the operation direction in accordance with a turning operation of any one of the operation handles 53L, 53T, 53R, and 53S. In other words, the switch electrifying the rotary motor 11 is configured to be an electric circuit including the first switch structure body 86 and the second switch structure body 87 respectively and independently corresponding to both the polarities.

Subsequently, the operation of the embodiment will be described. Each of the lifter operation handle 53L, the tilt operation handle 53T, the recliner operation handle 53R, and the slide operation handle 53S is substantially the same with each other except rotational force transmitted to the shafts 31L, 31T, 31R, and 31S related to the turning operation. Therefore, an operation of the lifter operation handle 53L will be described below as being representative.

Firstly, it is considered that the lifter operation handle 53L is not in operation, thereby being in a state where rotational force of the worm wheel 23 cannot be transmitted to the lifter shaft 31L, and connection between the rotary motor 11 and the DC power source is blocked via the first and second switch structure bodies 86 and 87. In this state, when the lifter operation handle 53L is in a turning operation clockwise or counterclockwise against biasing force of the torsion spring 55, the first cam member 51 turns in response to the rotational force transmitted through the gear portions 54L and 51d. Accordingly, the first cam member 51 is deviated from the neutral position, and the tubular member 35 moves so as to cause the fitting hole 38 of the tubular member 35 to house the fitting portion 27 of the worm wheel 23 by biasing force of the compression spring 39. Then, rotational force of the worm wheel 23 can be transmitted to the slide shaft 31S via the tubular member 35.

Meanwhile, when the lifter operation handle 53L is in a turning operation clockwise or counterclockwise, in response to the rotational force transmitted through the gear portions 54L and 62L, the lifter switch cam member 61L turns counterclockwise or clockwise coping with the operation direction of the lifter operation handle 53L. In this case, the switch lever 70 is pressed by any one of the pressing portions 65 and 66 of the switch cam portion 64L coping with the rotational direction of the lifter switch cam member 61L, thereby turning clockwise or counterclockwise about the switch support axis portion 18a. Then, as the switch lever 70 turns about the switch support axis portion 18a, the corresponding button between the buttons 86b and 87b is pressed by the switch pressing portion 73. Accordingly, the rotary motor 11 and the DC power source are connected to each other through the polarity coping with the pressed button between the buttons 86b and 87b (the movable terminals MT1 and MT2), and thus, the rotary motor 11 rotates normally or reversely. In other words, a button to be pressed is determined between the buttons 86b and 87b by the operation direction of the lifter operation handle 53L, thereby determining the rotational direction of the rotary motor 11.

As the rotary motor 11 rotates, the rotational force thereof is transmitted to the lifter shaft 31L via the input torque cable 12, the worm 22, the worm wheel 23, and the tubular member 35. Then, in response to the rotational force of the lifter shaft 31L, the lifter mechanism M1 is activated so as to lift and lower the seat 6 coping with the rotational direction.

Thereafter, when operating force of the lifter operation handle 53L is cancelled, the lifter operation handle 53L is biased by the torsion spring 55 and returns to the initial position. Accordingly, the first cam member 51 turns in response to the rotational force transmitted through the gear portions 54L and 51d against biasing force of the compression spring 39, and thus, the first cam member 51 returns to the neutral position. The biasing force of the torsion spring 55 which causes the lifter operation handle 53L to return to the initial position together with the first cam member 51 is greater than the biasing force of the compression spring 39 which moves the tubular member 35, as described above. Accordingly, rotational force of the worm wheel 23 cannot be transmitted to the lifter shaft 31L via the tubular member 35.

Meanwhile, in accordance with returning of the lifter operation handle 53L to the initial position, the lifter switch cam member 61L turns in response to the rotational force transmitted through the gear portions 54L and 62L, and the switch lever 70 returns to the initial turning position together with the corresponding buttons 86b and 87b, thereby blocking the connection between the rotary motor 11 and the power source. Accordingly, the rotary motor 11 stops rotating.

Other operation handles 53T, 53R, and 53S are operated in the same manner.

Particularly, in a state where the corresponding switch cam member among the switch cam members 61L, 61T, 61R, and 61S turns in accordance with a turning operation of any one of the operation handles 53L, 53T, 53R, and 53S, turning of other switch cam members among the switch cam members 61L, 61T, 61R, and 61S are regulated on account of cooperation of the pressed portion 75 and the regulation portion 76. Then, other operation handles among the operation handles 53L, 53T, 53R, and 53S are joined to other switch cam members among the switch cam members 61L, 61T, 61R, and 61S so as to be driven therewith become inoperative (prohibition on follow-up activation). In this case, since the two regulation portions 76 are provided in the switch lever 70, the structure can be prevented from being increased in size in order to prohibit follow-up activation.

As described above in detail, according to the embodiment, the following effects can be achieved.

(1) In the embodiment, the structure can be prevented from being increased in size in order to prohibit follow-up activation of the operation handles 53L, 53T, 53R, and 53S. Furthermore, it is possible to prevent the driving apparatus 10 from being increased in size in entirety thereof. In addition, the number of components can be much reduced as the stop cam in the example of the related art is no longer necessary, and thus, it is possible to achieve cost reduction.

(2) In the embodiment, the two buttons 86b and 87b of the first and second switch structure bodies 86 and 87 are arranged side by side in the circumferential direction centering around the rotary axis (the switch support axis portion 18a) of the switch lever 70, thereby being pressed down outwardly in the radial direction by the switch lever 70. Therefore, the first and second switch structure bodies 86 and 87 can receive pressing-down force from the switch lever 70 through the buttons 86b and 87b at high efficiency without hindering the turning of the switch lever 70.

(3) In the embodiment, the switches regarding electrification of the rotary motor 11 are respectively configured to be electric circuits in the first and second switch structure bodies 86 and 87 which are separate from each other. Therefore, general versatility can be much improved as the circuit can be configured in a simple combination. In addition, since the first and second switch structure bodies 86 and 87 are separately and intensively disposed about the switch lever 70, it is possible to prevent the driving apparatus 10 from being increased in size in the entirety thereof.

(4) In the embodiment, the plurality of positional adjustment mechanisms (M1 to M4) can be selectively activated with one rotary motor 11, the electrical configuration thereof can be simplified further. In addition, each of the plurality of tubular members 35 and the like (the clutch mechanisms) has a configuration (so-called shaft coupling) in which the output shaft (the lifter shaft 31L, the tilt shaft 31T, the recliner shaft 31R, and the slide shaft 31S) leading to the corresponding positional adjustment mechanism (M1 to M4) is connected to the worm wheels 23 and 24. Therefore, each of the plurality of tubular members 35 and the like (the clutch mechanisms) can be intensively disposed about the output shaft and the like, and thus, it is possible to decrease the apparatus further in size in the entirety thereof. Moreover, since the number of functions (the number of the positional adjustment mechanisms) regarding a positional adjustment of a seat can be as many increased as the number of the output shafts (four), it is possible to relax the constraints on the number of functions.

(5) In the embodiment, as the operation handles 53L, 53T, 53R, and 53S are caused to be in turning operations from the initial position, the rotary motor 11 can be electrified through the polarity coping with the operation direction by the first and second switch structure bodies 86 and 87 while connecting the corresponding clutch mechanism. Therefore, it is possible to rotate the rotary motor 11 normally or reversely in accordance with the operation direction of the operation handles 53L, 53T, 53R, and 53S. Thus, it is possible to set the operation direction of the operation handles 53L, 53T, 53R, and 53S and the adjustment direction of the positional adjustment mechanism (M1 to M4) so as to have a relationship easier to be grasped.

### Second Embodiment

Hereinafter, a second embodiment of the seat driving apparatus will be described. The second embodiment has a configuration in which the lifter operation handle and the slide operation handle of the first embodiment are mainly changed. Therefore, detailed description for the same portion will be omitted.

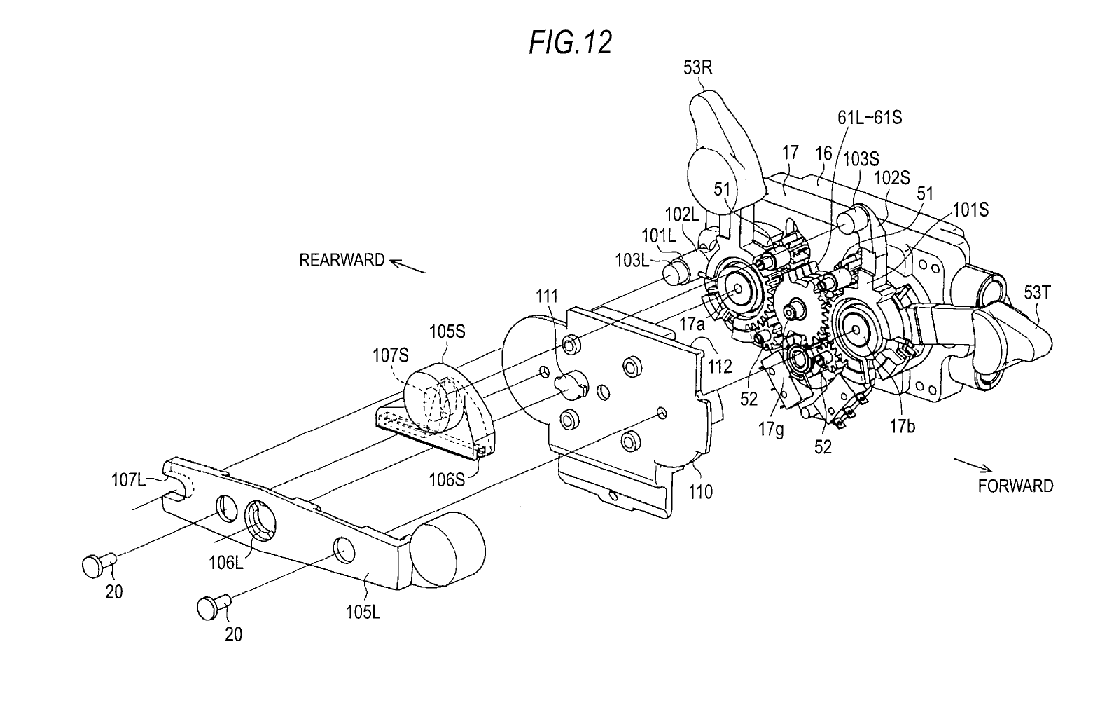

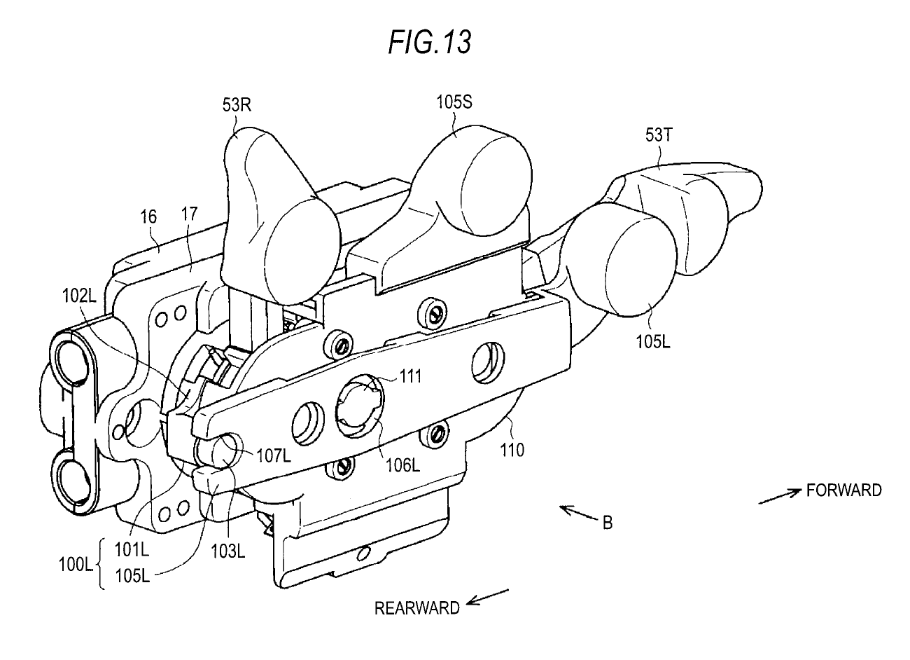

As illustrated in FIGS. 12 and 13, a lifter operation handle turning portion 101L (operation handle turning portion) in place of the lifter operation handle 53L is pivotally supported by the base end portion of the support axis portion 17a. The lifter operation handle turning portion 101L includes an extension piece 102L extending in a predetermined radial direction (obliquely upper left in FIG. 12, that is, rearward) centering around the support axis portion 17a, and a substantially columnar lifter engagement protrusion portion 103L (engagement protrusion portion) protrudes from the distal end of the extension piece 102L in parallel to the support axis portion 17a.

The lifter operation handle turning portion 101L includes the gear portion 54L in proportion to the lifter operation handle 53L. The torsion spring 55 is wound about the support axis portion 17a which is the inner circumferential side of the lifter operation handle turning portion 101L. As the lifter operation handle turning portion 101L is biased by the torsion spring 55 in proportion to the lifter operation handle 53L, the extension piece 102L is held at a predetermined initial position extending in the rear of the support axis portion 17a. In this case, it is needless to mention that the first cam member 51 which integrally turns with the lifter operation handle turning portion 101L is set so as to be disposed at the neutral position.

Meanwhile, a slide operation handle turning portion 101S (operation handle turning portion) in place of the slide operation handle 53S is pivotally supported by the distal end portion of the support axis portion 17b. The slide operation handle turning portion 101S includes an extension piece 102S extending in a predetermined radial direction (upward in FIG. 12) centering around the support axis portion 17b, and a substantially columnar slide engagement protrusion portion 103S (engagement protrusion portion) protrudes from the distal end of the extension piece 102S in parallel to the support axis portion 17b.

The slide operation handle turning portion 101S includes the gear portion 54S in proportion to the slide operation handle 53S. The torsion spring 56 is wound about the support axis portion 17b which is the inner circumferential side of the slide operation handle turning portion 101S. As the slide operation handle turning portion 101S is biased by the torsion spring 56 in proportion to the slide operation handle 53S, the extension piece 102S is held at a predetermined initial position of the support axis portion 17b extending upward. In this case, it is needless to mention that the second cam member 52 which integrally turns with the slide operation handle turning portion 101S is set so as to be disposed at the neutral position.

A cover 110 in proportion to the cover 18 forming the casing together with the main body cases 16 and 17 is fastened to the main body case 17 as the two screws 20 are respectively fastened to the two support axis portions 17a and 17b in a state of covering the main body case 17 from outside. Accordingly, the operation handle turning portions 101L and 101S are positioned in the axial line direction together with the operation handles 53T and 53R. In this case, similarly to the first embodiment, as the distal end of the switch cam support axis portion 17g fits the cover 110, the switch cam members 61L, 61T, 61R, and 61S are positioned in the axial line direction. Moreover, each of the first cam member 51 and the second cam member 52 is positioned in the axial line direction by being pivotally supported by the cover 110.

In the cover 110, a substantially columnar lifting support axis portion 111 protrudes from a linear intermediate portion connecting the axial line of the support axis portion 17a and the axial line of the switch cam support axis portion 17g with each other in parallel to the axial lines thereof. The upper end of the cover 110 forms a slide guide portion 112 having a flange attached thereto and extending straight in the front-back direction.

A substantially elongated lifter operation handle knob 105L (operation handle knob) extending in the front-back direction is turnably joined to the cover 110. In other words, the lifter operation handle knob 105L includes a bearing hole 106L formed so as to face the lifting support axis portion 111, and is turnable about the lifting support axis portion 111 as the lifting support axis portion 111 is inserted into the bearing hole 106L and wheel-locked therein. The lifter operation handle knob 105L configures a lifter operation handle 100L together with the lifter operation handle turning portion 101L.

The front end portion of the lifter operation handle knob 105L protrudes farther to the front than the cover 110. Meanwhile, a substantially U-shaped lifter engagement groove 107L (engagement concave portion) which is open rearward is formed at the rear end of the lifter operation handle knob 105L. The lifter operation handle knob 105L can mutually transmit turning force with the lifter operation handle turning portion 101L as the lifter engagement protrusion portion 103L of the lifter operation handle turning portion 101L is engaged into the lifter engagement groove 107L. For example, when the lifter operation handle knob 105L is in operation, in response to the turning about the bearing hole 106L thereof, the lifter operation handle turning portion 101L of which the lifter engagement protrusion portion 103L is pressed by the inner wall surface of the lifter engagement groove 107L turns about the support axis portion 17a.

Even though the turning centers of the lifter operation handle turning portion 101L and the lifter operation handle knob 105L are different from each other, misalignment is absorbed by moving the lifter engagement protrusion portion 103L in the front-back direction in the lifter engagement groove 107L. In this case, since the turning center of the lifter operation handle knob 105L is positioned nearer to the front than the turning center of the lifter operation handle turning portion 101L, for example, the lifter operation handle turning portion 101L can be sufficiently turnable by less operation quantity applied to the front end portion of the lifter operation handle knob 105L. As described above, since the lifter operation handle knob 105L is biased by the torsion spring 55 so as to be held at a predetermined initial position, the lifter operation handle knob 105L in which operation force is cancelled is also held at the predetermined initial position being coupled thereto.

A substantially triangular slide operation handle knob 105S (operation handle knob) is movably supported by the cover 110 in the front-back direction. In other words, a slide guide groove 106S extending in the front-back direction and having a substantially L-shaped cross section is formed at the lower end of the slide operation handle knob 105S and the slide operation handle knob 105S is movable in the front-back direction as the slide guide portion 112 is fitted through the slide guide groove 106S. The slide operation handle knob 105S configures a slide operation handle 100S together with the slide operation handle turning portion 101S.

The upper end portion of the slide operation handle knob 105S protrudes upward further than the cover 110. Then, a long hole-shaped slide engagement groove 107S (engagement concave portion) extending in the vertical direction is formed at the upper end portion of the slide operation handle knob 105S. The slide operation handle knob 105S converts linear motion of the slide operation handle knob 105S into turning motion of the slide operation handle turning portion 101S, for example, as the slide engagement protrusion portion 103S of the slide operation handle turning portion 101S engages with the slide engagement groove 107S. For example, when the slide operation handle knob 105S is in operation, the slide operation handle turning portion 101S of which the slide engagement protrusion portion 103S is pressed by the inner wall surface of the slide engagement groove 107S in accordance with movement in the front-back direction along the slide guide portion 112 turns about the support axis portion 17b.

Even though the form of motion of the slide operation handle turning portion 101S and the slide operation handle knob 105S differs from each other, misalignment in the vertical direction is absorbed by moving the slide engagement protrusion portion 103S inside the slide engagement groove 107S. As described above, as the slide operation handle knob 105S is biased by the torsion spring 56 and is held at a predetermined initial position, the slide operation handle knob 105S in which operation force is cancelled is also held at the predetermined initial position above the slide guide portion 112 being coupled thereto.

Subsequently, the operation of the embodiment will be described.

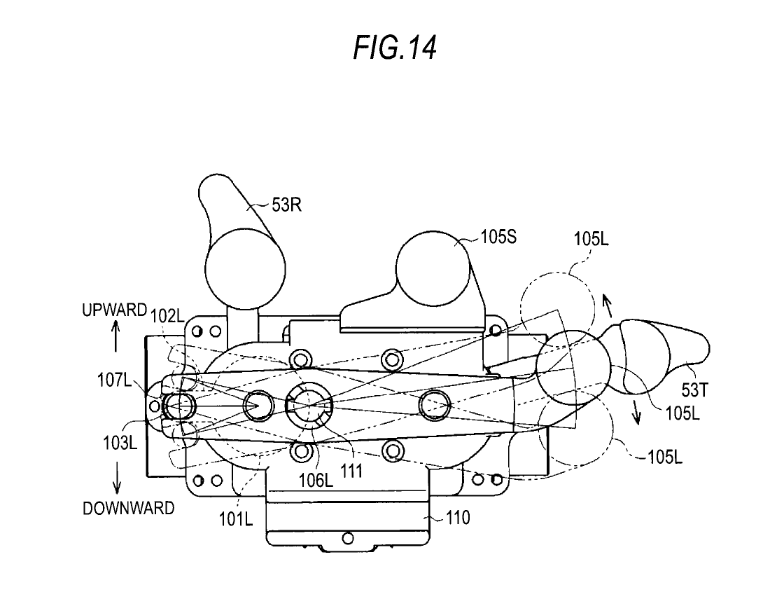

As illustrated in FIG. 14, for example, when the front end portion of the lifter operation handle knob 105L is moved upward, that is, when the lifter operation handle knob 105L is caused to turn counterclockwise as illustrated about the lifting support axis portion 111, the lifter operation handle turning portion 101L of which the lifter engagement protrusion portion 103L is pressed by the inner wall surface of the lifter engagement groove 107L turns counterclockwise as illustrated about the support axis portion 17a.

In contrast, when the front end portion of the lifter operation handle knob 105L is moved downward, that is, when the lifter operation handle knob 105L is caused to turn clockwise as illustrated about the lifting support axis portion 111, in proportion to above description, the lifter operation handle turning portion 101L turns clockwise as illustrated (opposite direction) about the support axis portion 17a.

In these cases, since the lifter engagement protrusion portion 103L moves in the front-back direction inside the lifter engagement groove 107L, misalignment caused by the two different turning centers of the lifter operation handle turning portion 101L and the lifter operation handle knob 105L is absorbed. The activation of the lifter mechanism M1 coping with the turning direction of the lifter operation handle turning portion 101L is the same as that in the first embodiment.

In order to relieve discomfort in an operation of the lifter operation handle knob 105L, it is preferable that the operation direction of the lifter operation handle knob 105L and the adjustment direction for the vertical position of the seat 6 controlled by the lifter mechanism M1 coincide with each other. Specifically, it is preferable that when the front end portion of the lifter operation handle knob 105L is moved upward, the lifter mechanism M1 is set to cause the vertical position of the seat 6 to move upward, and when the front end portion of the lifter operation handle knob 105L is moved downward, the lifter mechanism M1 is set to cause the vertical position of the seat 6 to move downward.

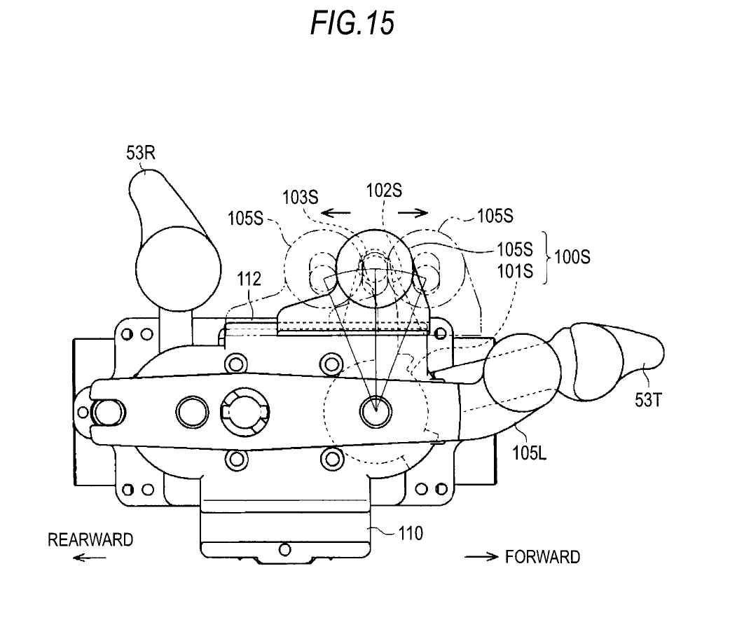

Meanwhile, as illustrated in FIG. 15, for example, when the slide operation handle knob 105S is cause to slide forward, the slide operation handle turning portion 101S of which the slide engagement protrusion portion 103S is pressed forward by the inner wall surface of the slide engagement groove 107S turns clockwise as illustrated about the support axis portion 17b.

In contrast, when the slide operation handle knob 105S is caused to slide rearward, in proportion to above description, the slide operation handle turning portion 101S turns counterclockwise as illustrated (opposite direction) about the support axis portion 17a.

In these cases, since the slide engagement protrusion portion 103S moves in the vertical direction inside the slide engagement groove 107S, misalignment in the vertical direction caused by the two different motion forms of the slide operation handle turning portion 101S and the slide operation handle knob 105S is absorbed. The activation of the slide mechanism M4 coping with the turning direction of the slide operation handle turning portion 101S is the same as that in the first embodiment.

In order to relieve discomfort in an operation of the slide operation handle knob 105S, it is preferable that the operation direction thereof and the adjustment direction for the front-back position of the seat 6 controlled by the slide mechanism M4 coincide with each other. Specifically, it is preferable that when the slide operation handle knob 105S is moved to the front, the slide mechanism M4 is set to move the front-back position of the seat 6 to the front, whereas when the slide operation handle knob 105S is moved to the rear, the slide mechanism M4 is set to move the front-back position of the seat 6 to the rear.

As described above in detail, according to the embodiment, the following effects can be achieved in addition to the effect of the first embodiment.

(1) In the embodiment, in the slide mechanism M4, the slide operation handle turning portion 101S and the slide operation handle knob 105S operating the corresponding tubular member 35 (the clutch mechanism) are in separate bodies, and the slide operation handle knob 105S is operated in linear motion in the front-back direction. Therefore, the slide operation handle knob 105S can be operated in a state instinctively closer to the slide mechanism M4 of which adjustment is performed in linear motion in the front-back direction.

(2) In the embodiment, in the lifter mechanism M1, since the lifter operation handle turning portion 101L and the lifter operation handle knob 105L operating the corresponding tubular member 35 (the clutch mechanism) are in separate bodies, the lifter operation handle knob 105L can be disposed at a position so as to be easier to be operated, and thus, operability can be improved further. Specifically, since the lifter operation handle knob 105L can be operated in the front end thereof, for example, compared to a case of being operated in the rear of the driving apparatus, it is possible to reduce crampedness for a person of particularly large size or an occupant in a small vehicle having the narrow inner space. Such crampedness is caused by being in a cramped posture such that the arms are in a crouched state while being hampered by one's arms and shoulder due to the short distance with respect to the seatback 8, for example.

(3) In the embodiment, since the support axis portion 17a (second turning axis) is disposed so as to be nearer to the lifter engagement protrusion portion 103L or the lifter engagement groove 107L than the lifting support axis portion 111 and the like (first turning axis), the turning quantity of the lifter operation handle knob 105L can be decreased further than the turning quantity of the lifter operation handle turning portion 101L. Accordingly, the operation quantity of the lifter operation handle knob 105L at the front end which is the operation position of the lifter operation handle knob 105L can be reduced further. Moreover, interference with respect to the peripheral components can be prevented.

The embodiment can be changed as follows.
In the first embodiment, all of the operation handles 53L, 53T, 53R, and 53S may be pivotally supported so as to turn about the rotary axes differing from each other.
In the first embodiment, all of the operation handles 53L, 53T, 53R, and 53S may be coaxially disposed with each other.
In the first embodiment, the operation handles 53L, 53T, 53R, and 53S integrally formed with the switch cam members 61L, 61T, 61R, and 61S may be employed. In other words, the switch cam portions 64L, 64T, 64R, and 64S (the pressing portions 65 and 66) may be provided in the operation handles 53L, 53T, 53R, and 53S which are the switch cam members coaxially disposed with each other.
In the second embodiment, the lifter engagement groove 107L may have a closed rear portion as long as misalignment of the lifter engagement protrusion portion 103L can be absorbed. In addition, the lifter engagement groove 107L may be a concave portion not penetrating the lifter operation handle knob 105L in a plate-thickness direction.
In the second embodiment, the slide engagement groove 107S may have an open upper portion as long as misalignment of the slide engagement protrusion portion 103S can be absorbed. In addition, the slide engagement groove 107S may penetrate the slide operation handle knob 105S in the plate-thickness direction.
In the second embodiment, the disposition relationship between the lifter operation handle turning portion 101L and the lifter operation handle knob 105L, and the lifter engagement protrusion portion 103L and the lifter engagement groove 107L may be reversely formed. In other words, the lifter engagement groove may be formed in the lifter operation handle turning portion, and the lifter engagement protrusion portion may protrude in the lifter operation handle knob.
In the second embodiment, the disposition relationship between the slide operation handle turning portion 101S and the slide operation handle knob 105S, and the slide engagement protrusion portion 103S and the slide engagement groove 107S may be reversely formed. In other words, the slide engagement groove may be formed in the slide operation handle turning portion, and the slide engagement protrusion portion may protrude in the slide operation handle knob.
In the second embodiment, the lifter operation handle knob which is operated in linear motion in the vertical direction in proportion to the slide operation handle knob 105S may be employed. In this case, the slide operation handle knob can be operated in a state instinctively closer to the lifter mechanism M1 of which adjustment is performed in linear motion in the vertical direction.
In the second embodiment, the slide operation handle knob which is disposed at a position so as to be easier to be operated in proportion to the lifter operation handle knob 105L may be employed.
In the second embodiment, the tilt operation handle 53T or the recliner operation handle 53R may be divided into the operation handle turning portion and the operation handle knob, thereby providing the operation handle knob which is similarly operated in linear motion, or providing the operation handle knob which is disposed at a position so as to be easier to be operated.
In each embodiment, in place of the worm 22 and the worm wheels 23 and 24, helical gears which mesh with each other may be employed. In this case, rotational force may be transmitted by performing speed reduction between the two helical gears, or may be transmitted at the equivalent speed.
In the embodiment, the intermediary member 40 may be omitted, and the pressing piece 37 of the tubular member 35 may be directly pressed by the cam portions 51b and 52b of the first and second cam members 51 and 52.
In each embodiment, the operation handles 53L, 53T, 53R, and 53S do not have to extend in the radial direction centering around the axial lines thereof.
In the embodiment, the switch structure body configured to be in one component in which the first and second switch structure bodies 86 and 87 are integrated may be employed.
In each embodiment, the buttons 86b and 87b coupled with the movable terminals MT1 and MT2 do not have to be arranged side by side in the circumferential direction centering around the switch support axis portion 18a. For example, the buttons may be arranged side by side in the front-back direction and may be pressed downward in response to the turning of the switch lever 70.
In each embodiment, any one of the worm wheels 23 and 24 may be omitted so as to provide a two-system output (that is, two positional adjustment mechanisms). Otherwise, a three-system output may be employed having an output which can be connected to one of the worm wheels 23 and 24 as one system (that is, three positional adjustment mechanisms).

Subsequently, technological idea that can be grasped from the above-described embodiments and other examples will be additionally described.

(A) In the seat driving apparatus, when none of the plurality of operation members is in operation, a clearance gap in the circumferential direction centering around the rotary axis of the switch lever is formed between each of the two pressing portions with which the switch cam portion can press the pressed portion and the pressed portion in all of the plurality of switch cam members.

According to the configuration, when none of the plurality of operation members is in operation, clearance gaps are respectively formed between the two pressing portions of the switch cam portion and the pressed portion of the switch lever. Therefore, when any one of the plurality of operation members is in operation, the pressing portion of one corresponding switch cam portion presses the pressed portion of the switch lever passing through the free running section of the clearance gap. Accordingly, the switch lever turns about the rotary axis thereof. In this case, since the clearance gap is formed between the pressed portion of the switch lever and the other pressing portion of the switch cam member (the switch cam portion) corresponding to other operation members not in operation, it is possible to prevent the pressed portion of the switch lever from pressing the other pressing portion of other switch cam members so as to integrally turn thereof.

In addition, when the switch lever turns, the pressed portion passes through the free running section of the clearance gap between the switch cam member (the switch cam portion) corresponding to other operation members and other pressing portion, thereby coming into contact with or approaching the pressing portion. Therefore, the pressed portion of the switch lever can regulate turning of other switch cam members (the switch cam portions).

(B) In the seat driving apparatus, each of the clutch mechanisms is the shaft coupling which selectively connects an output shaft leading to the corresponding positional adjustment mechanism and an input shaft being rotationally driven by the rotary motor.

According to the configuration, since each of the clutch mechanisms is the shaft coupling which selectively connects the output shaft and the input shaft, it is possible to be intensively disposed about the output shaft and the like. Thus, the apparatus can be decreased in size in the entirety thereof.

A seat driving apparatus according to an aspect of this disclosure includes a rotary motor; a plurality of operation members that are individually arranged so as to correspond to a plurality of positional adjustment mechanisms; a plurality of clutch mechanisms that are individually arranged so as to correspond to the plurality of positional adjustment mechanisms and selectively connect the corresponding positional adjustment mechanism with the rotary motor in accordance with an operation of any one of the plurality of operation members; a plurality of switch cam members that share a same first rotary axis so as to be pivotally supported thereabout, are respectively joined to the plurality of operation members so as to be driven therewith, and respectively include switch cam portions; a switch lever that is pivotally supported about a second rotary axis different from the first rotary axis of the plurality of switch cam members, includes a pressed portion protruding in a radial direction and a pair of regulation portions protruding in the radial direction from both sides interposing the pressed portion in a circumferential direction, causes the pressed portion to be pressed by the corresponding switch cam portion of the switch cam member so as to turn when any one of the plurality of operation members is in operation, and causes the regulation portion to block turning tracks of other switch cam portions of the switch cam members during the turning thereof; and a switch that electrifies the rotary motor through a polarity coping with a turning direction in response to the turning of the switch lever.

According to this configuration, when any one of the plurality of operation members is in operation, the corresponding switch cam member turns and the switch cam portion presses the pressed portion of the switch lever. In response thereto, the switch lever turns so that the switch electrifies the rotary motor through a polarity coping with the turning direction. Moreover, when any one of the plurality of operation members is in operation, the corresponding clutch mechanism connects the positional adjustment mechanism with the rotary motor. Therefore, the corresponding positional adjustment mechanism can be activated by operating any one of the plurality of operation members.

Particularly, when the switch lever turns, the regulation portion blocks the turning tracks of the switch cam portions of other switch cam members, thereby regulating turning of other switch cam members. Therefore, other operation handles which are respectively joined to other switch cam members so as to be driven therewith become inoperative (prohibition on follow-up activation). In this case, since the pair of regulation portions are provided in the switch lever, a structure can be prevented from being increased in size in order to prohibit follow-up activation.

In the seat driving apparatus described above, it is preferable that a switch structure body including the switch has a pair of buttons which are selectively pressed down by the switch lever coping with the turning direction of the switch lever, and the switch structure body is configured to electrify the rotary motor through the corresponding polarity when any one of the buttons is pressed down. It is preferable that the two buttons are arranged side by side in the circumferential direction centering around the second rotary axis of the switch lever and are pressed down outwardly from the switch lever in the radial direction by the switch lever.

According to this configuration, the two buttons are arranged side by side in the circumferential direction centering around the rotary axis of the switch lever and are pressed down outwardly in the radial direction by the switch lever. Therefore, the switch structure body can receive pressing-down force from the switch lever through the button at high efficiency without hindering the turning of the switch lever.

In the seat driving apparatus described above, it is preferable that the switch structure body is configured to include a first switch structure body which includes one of the two buttons pressed down by the switch lever in response to the turning of the switch lever in one direction, and a second switch structure body which is independent of the first switch structure body and includes the other of the two buttons pressed down by the switch lever in response to the turning of the switch lever in the other direction.

According to this configuration, the switches are respectively configured to be electric circuits in the first switch structure body and the second switch structure body which are separate from each other. Therefore, general versatility can be much improved as the circuit can be configured in a simple combination.

In the seat driving apparatus described above, it is preferable that the switch cam portion includes first and second pressing portions that can press the pressed portion, and when none of the plurality of operation members is in operation, a clearance gap in the circumferential direction centering around the second rotary axis of the switch lever is formed between each of the first and second pressing portions of the switch cam portion and the pressed portion in all of the plurality of switch cam members.

In the seat driving apparatus described above, it is preferable that each of the clutch mechanisms is a shaft coupling which selectively connects an output shaft leading to the corresponding positional adjustment mechanism and an input shaft being rotationally driven by the rotary motor.

In the seat driving apparatus described above, it is preferable that at least one of the plurality of operation members includes an operation handle knob that has one of an engagement concave portion and an engagement protrusion portion inserted movably into the engagement concave portion, and is movably supported on a straight line, and an operation handle turning portion that has the other one of the engagement concave portion and the engagement protrusion portion, is rotatable, causes the engagement protrusion portion to move in the engagement concave portion in accordance with an operation of the operation handle knob, rotates by a pressing force between the engagement concave portion and the engagement protrusion portion, and connects the positional adjustment mechanism with the rotary motor by the corresponding clutch mechanism.

According to this configuration, the operation handle turning portion and the operation handle knob operating the corresponding clutch mechanism are in separate bodies, and the operation handle knob 105S is operated in linear motion. Therefore, the operation handle knob can be operated in a state instinctively closer to the positional adjustment mechanism of which adjustment is performed in linear motion.

In the seat driving apparatus described above, it is preferable that at least one of the plurality of operation members includes an operation handle knob that has one of an engagement concave portion and an engagement protrusion portion inserted movably into the engagement concave portion, and is rotatably supported around a first turning axis, and an operation handle turning portion that has the other one of the engagement concave portion and the engagement protrusion portion, is rotatably supported around a second turning axis that is different from the first turning axis, causes the engagement protrusion portion to move in the engagement concave portion in accordance with an operation of the operation handle knob, rotates by a pressing force between the engagement concave portion and the engagement protrusion portion, and connects the positional adjustment mechanism with the rotary motor by the corresponding clutch mechanism.

According to this configuration, since the operation handle turning portion and the operation handle knob operating the corresponding clutch mechanism are in separate bodies, the operation handle knob can be disposed at a position so as to be easier to be operated, and thus, operability can be improved further.

In the seat driving apparatus described above, it is preferable that the operation position of the operation handle knob is disposed on opposite side of the engagement concave portion or the engagement protrusion portion across the first turning axis, and the second turning axis is disposed at a position that is nearer to the engagement concave portion or the engagement protrusion portion than the first turning axis.

According to this configuration, since the second turning axis is disposed so as to be nearer to the engagement protrusion portion or the concave portion than the first turning axis, the turning quantity of the operation handle knob can be decreased further than the turning quantity of the operation handle turning portion. Accordingly, the operation quantity of the operation handle knob which is the operation position of the operation handle knob can be reduced further. Moreover, interference with respect to the peripheral components can be prevented.

The aspect of this disclosure provides an effect of preventing a structure from being increased in size in order to prohibit follow-up activation of operation handles.

The principles, preferred embodiment and mode of operation of the present invention have been described in the foregoing specification. However, the invention which is intended to be protected is not to be construed as limited to the particular embodiments disclosed. Further, the embodiments described herein are to be regarded as illustrative rather than restrictive. Variations and changes may be made by others, and equivalents employed, without departing from the spirit of the present invention. Accordingly, it is expressly intended that all such variations, changes and equivalents which fall within the spirit and scope of the present invention as defined in the claims, be embraced thereby.

What is claimed is:

1. A seat driving apparatus comprising:
a rotary motor;
a plurality of operation members that are individually arranged so as to correspond to a plurality of positional adjustment mechanisms;
a plurality of clutch mechanisms that are individually arranged so as to correspond to the plurality of positional adjustment mechanisms and selectively connect the corresponding positional adjustment mechanism with the rotary motor in accordance with an operation of any one of the plurality of operation members;
a plurality of switch cam members that share a same first rotary axis so as to be pivotally supported thereabout, are respectively joined to the plurality of operation members so as to be driven therewith, and respectively include switch cam portions;
a switch lever that is pivotally supported about a second rotary axis different from the first rotary axis of the plurality of switch cam members, includes a pressed portion protruding in a radial direction and a pair of regulation portions protruding in the radial direction from both sides interposing the pressed portion in a circumferential direction, causes the pressed portion to be pressed by the corresponding switch cam portion of the switch cam member so as to turn when any one of the plurality of operation members is in operation, and causes the regulation portion to block turning tracks of other switch cam portions of the switch cam members during the turning thereof; and
a switch that electrifies the rotary motor through a polarity coping with a turning direction in response to the turning of the switch lever.

2. The seat driving apparatus according to claim 1,
wherein a switch structure body including the switch has a pair of buttons which are selectively pressed down by the switch lever coping with the turning direction of the switch lever, and the switch structure body is configured to electrify the rotary motor through the corresponding polarity when any one of the buttons is pressed down, and
wherein the two buttons are arranged side by side in the circumferential direction centering around the second rotary axis of the switch lever and are pressed down outwardly from the switch lever in the radial direction by the switch lever.

3. The seat driving apparatus according to claim 2,
wherein the switch structure body is configured to include a first switch structure body which includes one of the two buttons pressed down by the switch lever in response to the turning of the switch lever in one direction, and a second switch structure body which is independent of the first switch structure body and includes the other of the two buttons pressed down by the switch lever in response to the turning of the switch lever in the other direction.

4. The seat driving apparatus according to claim 1,
wherein the switch cam portion includes first and second pressing portions that can press the pressed portion, and
wherein when none of the plurality of operation members is in operation, a clearance gap in the circumferential direction centering around the second rotary axis of the switch lever is formed between each of the first and second pressing portions of the switch cam portion and the pressed portion in all of the plurality of switch cam members.

5. The seat driving apparatus according to claim 1,
wherein each of the clutch mechanisms is a shaft coupling which selectively connects an output shaft leading to the corresponding positional adjustment mechanism and an input shaft being rotationally driven by the rotary motor.

6. The seat driving apparatus according to claim 1,
wherein at least one of the plurality of operation members includes an operation handle knob that has one of an engagement concave portion and an engagement protrusion portion inserted movably into the engagement concave portion, and is movably supported on a straight line, and an operation handle turning portion that has the other one of the engagement concave portion and the engagement protrusion portion, is rotatable, causes the engagement protrusion portion to move in the engagement concave portion in accordance with an operation of the operation handle knob, rotates by a pressing force between the engagement concave portion and the engagement protrusion portion, and connects the positional adjustment mechanism with the rotary motor by the corresponding clutch mechanism.

7. The seat driving apparatus according to claim 1,
wherein at least one of the plurality of operation members includes an operation handle knob that has one of an engagement concave portion and an engagement protrusion portion inserted movably into the engagement concave portion, and is rotatably supported around a first turning axis, and an operation handle turning portion that has the other one of the engagement concave portion and the engagement protrusion portion, is rotatably supported around a second turning axis that is different from the first turning axis, causes the engagement protrusion portion to move in the engagement concave portion in accordance with an operation of the operation handle knob, rotates by a pressing force between the engagement concave portion and the engagement protrusion portion, and connects the positional adjustment mechanism with the rotary motor by the corresponding clutch mechanism.

8. The seat driving apparatus according to claim 5,
wherein an operation position of the operation handle knob is disposed on opposite side of the engagement concave portion or the engagement protrusion portion across the first turning axis,
wherein the second turning axis is disposed at a position that is nearer to the engagement concave portion or the engagement protrusion portion than the first turning axis.
